(19) United States
(12) Patent Application Publication
(10) Pub. No.: US 2025/0266971 A1
(43) Pub. Date: Aug. 21, 2025

(54) PROACTIVE SYNCHRONIZATION AND PHYSICAL BROADCAST CHANNEL SIGNAL BLOCK/ TRACKING REFERENCE SIGNAL RECEPTION PROCEDURE FOR HALF-DUPLEX OPERATION

(71) Applicant: Telefonaktiebolaget LM Ericsson (publ), Stockholm (SE)

(72) Inventors: Kazuyoshi UESAKA, Kawasaki Kanagawa (JP); Santhan THANGARASA, Vällingby (SE); Muhammad Ali KAZMI, Sundbyberg (SE); Zhixun TANG, Beijing (CN); Zhanxian WANG, Täby (SE)

(21) Appl. No.: 18/702,438

(22) PCT Filed: Oct. 21, 2022
(86) PCT No.: PCT/EP2022/079394

§ 371 Date: Apr. 18, 2024

(30) Foreign Application Priority Data
Oct. 22, 2021 (WO) PCT/CN2021/125666

(51) Int. Cl. H04L 5/00; H04L 5/16; H04W 74/0833

(52) U.S. Cl. CPC H04L 5/0078; H04L 5/0048; H04L 5/16; H04W 74/0833

(57) ABSTRACT

A method and wireless device (WD) for proactive synchronization signal and physical broadcast channel signal block (SSB)/tracking reference signal (TRS) reception procedures for half-duplex operation are disclosed. According to one aspect, a method in a WD includes determining whether a first signal reception (FSR) condition is met, the FSR condition including one of receipt and availability of at least N first signals during a time interval ΔT ending at a time T2, N being an integer greater than zero. The method also includes, when the FSR condition is met, operating a second signal on a radio resource at the time T2.

### TECHNICAL FIELD

The present disclosure relates to wireless communications, and in particular, to proactive synchronization signal and physical broadcast channel signal block (SSB)/tracking reference signal (TRS) reception procedures for half-duplex operation.

### BACKGROUND

The Third Generation Partnership Project (3GPP) has developed and is developing standards for Fourth Generation (4G) (also referred to as Long Term Evolution (LTE)) and Fifth Generation (5G) (also referred to as New Radio (NR)) wireless communication systems. Such systems provide, among other features, broadband communication between network nodes, such as base stations, and mobile wireless devices (WD), as well as communication between network nodes and between WDs. Sixth Generation (6G) wireless communication systems are also under development.

Wireless communication systems according to the 3GPP may include one or more of the following channels:
A physical downlink control channel, PDCCH;
A physical uplink control channel, PUCCH;
A physical downlink shared channel, PDSCH;
A physical uplink shared channel, PUSCH;
A physical broadcast channel, PBCH; and
A physical random access channel, PRACH.

3GPP Technical Release 17 (3GPP Rel-17) will introduce the reduced capability (RedCap) WDs which can facilitate the expansion of the NR device ecosystem to cater to the use cases that are not yet best served by 3GPP Rel-15/Rel-16 NR specifications targeting evolved mobile broadband (eMBB) and ultra-reliable and low latency communications (URLLC).

The use cases for NR RedCap include wearables (e.g., smart watches, wearable medical devices, AR/VR goggles, etc.), industrial wireless sensors, and video surveillance. One of the key requirements for RedCap WD is the battery lifetime and device size. For example, wearable devices require at least several days and up to 1-2 weeks and industrial wireless sensors require at least a few years for the battery life.

To achieve a small device size and/or longer battery lifetime, 3GPP has considered defining RedCap WDs by considering complexity reductions such as:
Bandwidth reduction, the maximum bandwidth may be limited to 20 MHz for FR1 and 100 MHz for FR2;
Reducing the maximum number of MIMO layers by 1, implying a single receive antenna;
Relaxation of the maximum downlink modulation order, i.e., RedCap WD does not support 256 quadrature amplitude modulation (QAM) or higher order modulation; and
Allowing half-duplex (HD) operations in frequency division duplex (FDD) bands. It helps reduce the bill of material costs in terms of antennas and radio frequency (RF) components.

When the WD is in IDLE/INACTIVE state, the WD monitors the PDCCH whose transmission occasions are configured by the gNB (hereafter referred to as a network node) every discontinuous reception (DRX) cycle. The DRX cycle may be 320 ms, 640 ms, 1280 ms, and 2560 ms. 3GPP Rel-17 extends the DRX to enable a longer DRX period, called extended DRX (eDRX). With eDRX, it is possible to extend the DRX cycle up to 2.91 hours.

In NR, a new association mechanism for paging was introduced. The paging occasions are associated with a synchronization signal (SS) burst. There are two possible ways to multiplex SSB and paging occasion (PO).
SSB frequency division multiplexed (FDMed) with PO; and
SSB time division multiplexed (TDMed) with PO.

The summary of length and periodicity of PDCCH monitoring for different patterns are given in Table 1.

TABLE 1

| | | Length of | | |
|---|---|---|---|---|
| | PDCCH | PDCCH | SFN in which | |
| | Monitoring | Monitoring | PDCCH Monitoring | |
| | Occasions | Occasion | Occasions are | Carrier |
| Patterns | Interval | per SSB | located | Frequency |
| Pattern 1 | Every 20 ms | 2 | a) SFN mod 2 = 0 | FR1, FR2 |
| | | consecutive | for all SSBs OR | |
| | | slots | b) SFN mod 2 = 0 | |
| | | | for some SSBs and | |
| | | | SFN mod 2 = 1 for | |
| | | | others. | |
| Pattern | SS burst set | 1 slot | SFN in which SS | FR2 |
| 2/3 | period | | burst set is | |
| | (5, 10, 20, | | transmitted. (Note: | |
| | 40, 80, | | SS burst set can be | |
| | 160) ms | | transmitted in any | |
| | | | radio frame of SS | |
| | | | burst set period. | |

The paging frequency (PF) and PO for paging are determined by the following formula. First, the system frame number (SFN) for the PF is determined by:

(SFN+PF_offset)mod T=(T div N)*(UE_ID mod N)

Index (i_s) indicates the index of the PO, and is determined by:

i_s=floor(UE_ID/N)mod Ns

The PDCCH monitoring occasions for paging are determined according to pagingSearchSpace as specified in 3GPP Technical Standard (TS) 38.213 [4] and firstPDCCH-MonitoringOccasionOfPO and nrofPDCCH-MonitoringOccasionPerSSB-InPO if configured as specified in 3GPP TS 38.331 [3]. When SearchSpaceId=0 is configured for pagingSearchSpace, the PDCCH monitoring occasions for paging are same as for remaining minimum system information (RMSI), for example, as defined in clause 13 in 3GPP TS 38.213.

When SearchSpaceId=0 is configured for pagingSearchSpace, Ns is either 1 or 2. For Ns=1, there is only one PO which starts from the first PDCCH monitoring occasion for paging in the PF. For Ns=2, a PO is either in the first half frame (i_s=0) or the second half frame (i_s=1) of the PF.

When SearchSpaceId other than 0 is configured for pagingSearchSpace, the WD monitors the (i_s+1)^{th} PO. A PO is a set of ‘S*X’ consecutive PDCCH monitoring occasions where ‘S’ is the number of actual transmitted SSBs determined according to ssb-PositionsInBurst in SIB1 and X is the nrofPDCCH-MonitoringOccasionPerSSB-InPO if configured or is equal to 1 otherwise. The [x*S+K]^{th} PDCCH monitoring occasion for paging in the PO corresponds to the K^{th} transmitted SSB, where x=0, 1, . . . , X−1, K=1, 2, . . . , S. The PDCCH monitoring occasions for paging which do not overlap with uplink (UL) symbols (determined according to tdd-UL-DL-ConfigurationCommon) are sequentially numbered from zero starting from the first PDCCH monitoring occasion for paging in the PF. When firstPDCCH-MonitoringOccasionOfPO is present, the starting PDCCH monitoring occasion number of (i_s+1)^{th} PO is the (i_s+1)^{th} value of the firstPDCCH-MonitoringOccasionOfPO parameter; otherwise, it is equal to i_s*S*X. If X>1. When the WD detects a PDCCH transmission addressed to P-radio network temporary identifier (RNTI) within its PO, the WD is not required to monitor the subsequent PDCCH monitoring occasions for this PO.

The 4-step random access (RA) procedure has been used in 4G LTE and is also the baseline for 5G NR. The principle of this procedure in NR is shown in FIG. 1.

### Step 1: Preamble Transmission

The WD randomly selects a RA preamble (PREAMBLE_INDEX) corresponding to a selected SS/PBCH block, and transmits the preamble on the PRACH occasion mapped by the selected SS/PBCH block. When the network node (NN) detects the preamble, it estimates the Timing advance (TA) the WD should use in order to obtain UL synchronization at the network node.

### Step 2: RA Response (RAR)

The network node, e.g., gNB, sends a RA response (RAR) including the TA, the TC-RNTI (temporary identifier) to be used by the WD, a Random Access Preamble identifier that matches the transmitted PREAMBLE_INDEX and a grant for Msg3. The WD expects the RAR and thus, monitors the PDCCH addressed to RA-RNTI to receive the RAR message from the network node until the configured RAR window (ra-ResponseWindow) has expired or until the RAR has been successfully received.

From 3GPP TS 38.321: “The MAC entity may stop ra-ResponseWindow (and hence monitoring for Random Access Response(s)) after successful reception of a Random Access Response containing Random Access Preamble identifiers that matches the transmitted PREAMBLE_INDEX.”

### Step 3: “Msg3” (UE ID or WD-Specific C-RNTI)

In Msg3, the WD transmits its identifier (UE ID) for initial access. Or, if the WD is already in RRC_CONNECTED or RRC_INACTIVE mode and needs to e.g., re-synchronize, for example, the WD sends its WD-specific radio network temporary identifier (RNTI). If the network node cannot decode Msg3 at the granted UL resources, it may send a downlink control information (DCI) message addressed to TC-RNTI for retransmission of Msg3. Hybrid automatic repeat request (HARQ) retransmission is requested until the WD restarts the random access procedure from step 1 after reaching the maximum number of HARQ retransmissions or until Msg3 may be successfully received by the network node.

### Step 4: “Msg4” (Contention Resolution)

In Msg4 the network node responds by acknowledging the WD ID or C-RNTI. The Msg4 gives contention resolution, i.e., only one WD ID or C-RNTI will be sent even if several WDs have used the same preamble (and the same grant for Msg3 transmission) simultaneously. For Msg4 reception, the WD monitors TC-RNTI (if it transmitted its WD ID in Msg3) or C-RNTI (if it transmitted its C-RNTI in Msg3).

The 2-step RA procedure gives much shorter latency than the ordinary 4-step RA. In the 2-step RA the preamble and a message corresponding to Msg3 (msgA PUSCH) in the 4-step RA can, depending on configuration, be transmitted in two subsequent slots. The msgA PUSCH is sent on a resource dedicated to the specific preamble. This means that both the preamble and the Msg3 face contention. However, contention resolution in this case means that either both preamble and Msg 3 are sent without collision or both collide. The 2-step RA procedure is depicted in FIG. 2.

Upon successful reception msgA, the network node will respond with a msgB. The msgB may be either a “successRAR”, “fallbackRAR or “Back off”. The content of msgB has been agreed as seen below. It is noted in particular that fallbackRAR provides a grant for a Msg3 PUSCH that identifies resources in which the WD should transmit the PUSCH, as well as other information.

Note: The notations “msgA” and “MsgA” are used interchangeably herein to denote message A. Similarly, the notations “msgB” and “MsgB” are used interchangeably herein to denote message B.

The possibility of replacing the 4-step message exchange by a 2-step message exchange would lead to reduced RA latency. On the other hand, the 2-step RA will consume more resources since it uses contention-based transmission of the data. This means that the resources that are configured for the data transmission may often be unused.

If both the 4-step and 2-step RA are configured in a cell on shared PRACH resources (and for the WD), the WD will choose its preamble from one set if it wants to do a 4-step RA, and from another set if it wants to do a 2-step RA. Hence, a preamble partition is created to distinguish between 4-step and 2-step RA when shared PRACH resources are used. Alternatively, the PRACH configurations are different for the 2-step and 4-step RA procedure. In this case, it may be deduced from where the preamble transmission is performed, whether the WD is performing a 2-step procedure or a 4-step procedure.

In the 3GPP Rel-16 2-step RA type procedure, WDs are informed of the potential time-frequency resources where they may transmit MsgA PRACH and MsgA PUSCH via higher layer signaling from the network node. PRACH is transmitted in periodically recurring RACH occasions (‘ROs’), while PUSCH is transmitted in periodically recurring PUSCH occasions (‘POs’). PUSCH occasions are described in MsgA PUSCH configurations provided by higher layer signaling. Each MsgA PUSCH configuration defines a starting time of the PUSCH occasions that is measured from the start of a corresponding RACH occasion. Multiple PUSCH occasions may be multiplexed in time and frequency in a MsgA PUSCH configuration, where POs in an orthogonal frequency division multiplexed (OFDM) symbol occupy a given number of physical resource blocks (PRBs) and are adjacent in frequency, and where POs occupy ‘L’ contiguous OFDM symbols. POs multiplexed in time in a MsgA PUSCH configuration may be separated by a configured gap that is ‘G’ symbols long. The start of the first occupied OFDM symbol in a PUSCH slot is indicated via a start and length indicator value (‘SLIV’). The MsgA PUSCH configuration may comprise multiple contiguous PUSCH slots, each slot containing the same number of POs. The start of the first physical resource block (PRB) relative to the first PRB in a bandwidth part (BWP) is also given by the MsgA PUSCH configuration. Moreover, the modulation and coding scheme (MCS) for MsgA PUSCH is also given by the MsgA PUSCH configuration.

Each PRACH preamble maps to a PUSCH occasion and a demodulation reference signal (DMRS) port and/or to a DMRS port-scrambling sequence combination according to a procedure given in 3GPP standards such as in, for example, 3GPP Technical Specification (TS) 38.213. This mapping allows a network node to uniquely determine the location of the associated PUSCH in time and frequency as well as the DMRS port and/or scrambling sequence from the preamble selected by the WD.

The PRACH preambles also map to associated SSBs. The SSB to preamble association combined with the preamble to PUSCH association allow a PO to be associated with a RACH preamble. This indirect preamble-to-PUSCH mapping may be used to allow a network node using analog beamforming to receive a MsgA PUSCH with the same beam that it uses to receive the MsgA RACH preamble.

In NR, since the network node will control the UL transmission to avoid the collision among WDs, the network node will assign the dedicated UL resources in frequency and time domain. One exception is the case when WD will make an initial access to the network node from IDLE/INACTIVE states. Random access is the procedure used when the WD initiates a connection with the network node. 3GPP has specified two types of random access procedures: 4-step RA type and 2-step RA type and these are described in detail in clause 2.1.3 of 3GPP TS 38.213.

Regardless of whether a 4-step RA procedure or a 2-step RA procedure is used, the WD must transmit a random access preamble using PRACH at the beginning of random access attempts. Since the network node does not know when the WD initiates the random access, the network node allocates the UL resources for PRACH periodically at a periodicity called RACH periodicity. RACH periodicity is configurable, e.g., 10 ms. 20 ms, 40 ms, 80 ms, and 160 ms.

FIG. 3 illustrates the relation between a RACH occasion and a paging period (or DRX cycle).

Connected mode DRX (C-DRX) is configured not to monitor the PDCCH every slot in CONNECTED mode to help WD save battery power. When C-DRX is configured, the WD is required to awake to monitor the PDCCH periodically. The WD can sleep (e.g., turn off some baseband circuits or clock down the baseband circuit) for the period the WD is not required to monitor the PDCCH. But the WD can awake and send the Scheduling Request during the sleep period if the WD has UL data scheduled from the upper layer.

Every time after the WD receives the PDCCH, the WD starts the inactivity timer (drx-InActivityTimer, e.g., 10 ms). This timer extends the monitoring period during which the WD needs to wake and monitor the PDCCH until the inactivity timer is expired. After the inactivity timer is expired, the WD can go to the short DRX cycle where the WD wakes and monitor the PDCCH every short DRX cycle (drx-ShortCycle, e.g., 10 ms). Every short DRX cycle, the WD awakes and monitors the PDCCH during ‘on duration’ given by drx-onDurationTimer, e.g., 2 ms. The WD continues short DRX activity during the period that the short DRX cycle timer is running. After the short DRX cycle timer is expired, the WD can go to the long DRX cycle, where the WD awakes and monitors the PDCCH every long DRX cycle (drx-LongCycle, e.g., 320 ms). Every short DRX cycle, the WD awakes and monitors the PDCCH during ‘on duration’ given by drx-onDurationTimer, e.g., 10 ms.

When the WD is in sleep mode, the WD does not receive any signals and uses its internal clock to schedule when the WD awakes for the next DRX cycle. Since the clock in the WD is not as accurate as the clock in the network node, the WD needs to re-synchronize to the network node in advance by receiving the common downlink signal such as SSB or TRS. Moreover, the WD may move to another location or change its direction during the sleep mode. This results in the changes on received signal level and hence, the WD may need to adjust the gain of the receiver's amplifier (i.e., low-noise amplifier, LNA) by using an automatic gain control (AGC) algorithm. The WD needs to receive SSB or TRS to run the AGC algorithm.

The WD can use the SS/PBCH block for time/frequency tracking and AGC. In NR, the SSB consists of primary and secondary synchronization signals (PSS and SSS) and the physical broadcast channel (PBCH). The WD may use, e.g., synchronization signals to re-synchronize to the network node and adjust the gain of the LNA of the receiver of the WD. The network node transmits SS/PBCH periodically, e.g., every 5 ms, 10 ms, 20 ms, 40 ms, 80 ms, and 160 ms. The periodicity is configured via radio resource control (RRC) parameters. However, a default periodicity of 20 ms is assumed during initial cell search. To support initial access and beam management, NR supports an SS burst set which consists of multiple SS blocks confined within a 5 ms window.

Another downlink (DL) reference signal (RS) that the WD can use for time/frequency tracking and AGC is the channel state information reference signal (CSI-RS) for tracking. CRS-RS for tracking is also referred to as the tracking reference signal (TRS). The network node transmits a TRS periodically, e.g., 10 ms, 20 ms, 40 ms or 80 ms.

There are several configured uplink (UL) resources for the WDs in CONNECTED mode: PUCCH, sounding reference signals (SRS), and Uplink configured transmission (CG-PUSCH):
PUCCH: PUCCH is allocated to transmit Scheduling Request (SR). When the WD requires UL resources for new UL transmission in the connected mode, the WD sends a SR using the configured PUCCH. The SR may be transmitted even if the WD is asleep in DRX. The SR is configured periodically, e.g., every 160 slots;
SRS: A sounding reference signal (SRS) is the UL reference signal transmitted by the WD. The network node uses SRS to measure the UL propagation channel condition. The network node can schedule aperiodic SRS transmission (i.e., one shot transmission), semi-persistent SRS transmission (transmit several SRS times periodically), and periodic SRS transmission. For the semi-persistent or periodic SRS transmission, the network node can configure the WD to transmit SRS e.g., every 160 slots;
CG-PUSCH: CG-PUSCH enables UL data transmission by pre-allocating resources to avoid SR and scheduling grant procedure before the UL data transmission. The main purpose of CG-PUSCH is for low-latency UL data transmission. Since the network node does not know when the WD has UL data to transmit, the network node can configure the preconfigured UL grant periodically, e.g., every 10 slots.

FIG. 4 illustrates the relationship between the configured UL resources and the On duration in C-DRX. This example also shows the SSB/TRS transmission.

3GPP NR defines three duplex schemes: Time Division Duplex (TDD), Full-duplex Frequency Division Duplex (FD-FDD) and Half-duplex Frequency Division Duplex (HD-FDD). In TDD operation, the WD and the network node use a single frequency band and switch between uplink and downlink transmission in the time domain. On the other hand, FDD uses two paired frequency bands, and one frequency is used for uplink and the other frequency is used for downlink transmission. A difference between full-duplex and half-duplex is that for FD-FDD operation, the WD can transmit and receive data simultaneously, while for HD-FDD operation, the WD switches between UL transmission and DL transmission in the time domain in the same fashion as for TDD. However, the WD uses different frequencies for UL and DL transmission. There is a difference in the behavior of the network node between HD-FDD and TDD operation, but the network node behaves the same for both the HD-FDD-configured WD and the FD-FDD-configured WD.

For the network node operating in FDD bands, the network node handles both HD-FDD WDs and FD-FDD WDs. The network node therefore schedules the SSB and the TRS, targeting both HD-FDD WDs and FD-FDD WDs. The WD should receive these channel signals for Cell ID detection, time/frequency tracking, and AGC regardless of regardless of full-duplex or half-duplex.

For a RedCap device, the support of FD-FDD is optional, i.e., it is not required to receive in the downlink frequency while transmitting in the uplink frequency, and vice versa. HD-FDD obviates the need for duplex filters. Instead, a switch may be used to select the transmitter or receiver to connect to the antenna. As a switch is less expensive than multiple duplexers, cost savings are achieved.

An FD-FDD WD requires two oscillators. One oscillator is used for an UL frequency and another oscillator is used for a DL frequency. In contrast, a HD-FDD WD may have only one oscillator, and the WD is configured to switch the frequency in time. This means that when the WD needs to receive DL signals, the WD tunes the oscillator frequency to a DL frequency and when the WD needs to transmit UL signals, the WD tunes the oscillator frequency to an UL frequency. An HD-FDD WD with a single oscillator requires a switching period or transmission period from DL frequency to UL frequency, T_{DL-to-UL}, and UL frequency to DL frequency, T_{UL-to-DL}. One example of transition time is T_{DL-to-UL}=T_{UL-to-DL}=1 ms.

In NR in RRC_INACTIVE state, a WD with infrequent periodic and/or aperiodic data can transmit a small amount of data, which is called small data transmission (SΔT). Small data transmission (SΔT) is therefore a procedure to transmit UL data by the WD in RRC_INACTIVE state. SΔT is performed with either random access (using RACH-based SΔT) or configured grant (CG) (using Configured Grant (CG) based SΔT). If the WD uses 4-step RA type for SΔT procedure, then the WD transmits the UL data in the Msg3. If the WD uses 2-step RA type for SΔT procedure, then the WD transmits UL data in the MsgA.

CG PUSCH resources are the PUSCH resources configured in advance for the WD. When there is uplink data available in the WD's buffer, it can immediately start uplink transmission using the pre-configured PUSCH resources without waiting for an UL grant from the network node, thus reducing the latency. NR supports CG type 1 PUSCH transmission and CG type 2 PUSCH transmission. For both types, the PUSCH resources (time and frequency allocation, periodicity, etc.) are preconfigured via dedicated RRC signaling. The CG type 1 PUSCH transmission is activated/deactivated by RRC signaling, while the CG type 2 PUSCH transmission is activated/deactivated by an UL grant using downlink control information (DCI) signaling. An association between CG resources and SSBs is configured for CG-based SΔT.

Upon arrival of the data in the WD buffer, the WD may decide whether to use the SΔT mechanism or the legacy mechanism (e.g., by sending the RRCResumeRequest) to transmit the data based on comparison between the reference signal received power (RSRP) of a configured RS and an RSRP threshold (e.g., RSRP-threshold-STD). For example, an SΔT mechanism is selected if the RSRP is above the RSRP-threshold-STD; otherwise a legacy mechanism is used. The WD selects the CG-SΔT resource for transmission based on comparison between the RSRP of configured RS and an the RSRP threshold. For example, CG-SΔT resources associated with or corresponding to a RS (e.g., SSB) whose RSRP is above an RSRP threshold (e.g., RSRP-thresholdCG) are selected by the WD for data transmission

Even if the WD is operated in half-duplex FDD (HD-FDD) mode, the network node (e.g., gNB) still operates in full-duplex FDD (FD-FDD). The network node needs to configure common DL resources for both full-duplex WDs and half-duplex WDs, e.g., SSB/TRS/SIB/Paging. There are also common UL resources which are scheduled for both full-duplex WDs and half-duplex WDs, e.g., random access occasion (RO) and PUCCH transmission.

Sometimes, the network node cannot avoid the case that DL signal reception and UL transmission (e.g., paging reception and PUCCH transmission) overlap with each other fully or partly in time. The WD, after waking up from a period of inactivity (e.g., DRX OFF, eDRX), has to perform resynchronization (e.g., time and/or frequency tracking, AGC, automatic frequency control (AFC)) towards the serving cell to be able to receive DL channels/signals or transmit UL channels/signals). Different types of DL reference signals may be used for this purpose. At the same time, in NR, the PO is associated with SSB index. The WD can only monitor the paging based on the best SSB in terms of its received signal at the WD, e.g., SSB which gives largest signal strength measurement at the WD (e.g., SSB with largest RSRP). However, since the HD-FDD WD cannot receive and transmit simultaneously, the measurement occasions may be quite limited compared to a FD-FDD WD. The WD behavior in this overlapping scenario is currently undefined.

### SUMMARY

Some embodiments advantageously provide methods, systems, and apparatuses for proactive (SSB)/(TRS) reception procedures for half-duplex operation.

Some embodiments are applicable to a scenario with a WD (e.g., WD1) operating in HD-FDD mode served by a cell (cell1) managed by a network (e.g., NW1), and there is an overlap or conflict between UL transmission and DL reception in time. One example of UL transmission is random access transmission, and one example of DL reception is reception of a DL reference signal (RS), e.g., SSB.

In some embodiments, a WD configured in HD-FDD mode and served by a first cell (cell1), and configured to operate a second signal (S2) in a radio resource (Rr) starting at a time instance, T2, determines whether a first signal reception (FSR) condition is met by the WD, and determines whether the WD operates S2 in Rr based on whether the FSR is met by the WD.

FSR is determined by a rule, which may be pre-defined or configured by the network node. In one example of the rule, the WD meets FSR provided that the WD can receive at least N number of a first signal (S1) or at least N number of S1 is available at the WD during a time period (ΔT) before T2 or between time instances T1 and T2; where ΔTΔT=T2−T1 and T1<T2, e.g., T1 is the time instance occurring before T2.

If the WD fulfills at least one FSR condition, then the WD is expected to operate or it can operate or is required to operate S2 in the resource Rr. Otherwise, the WD is not expected to operate or is not required to operate or may not operate S2 in the resource Rr. In the latter case, the WD may further postpone or discard the operation of S2.

Examples of operating a signal may include transmitting a signal, receiving a signal or both transmitting and receiving a signal.

Examples of S1 are reference signals (RS) e.g., PSS, SSS, SS/PBCH block (SSB), CSI-RS, DMRS, PRS, etc.

Examples of DL S2 signals include paging, system information (S1) (e.g., SIB1, SIB2, etc.).

Examples of UL S2 signals include random access (RA), SRS, msgA, msg1, etc.

Some embodiments with S2 as a paging signal may include one or more of the following:
In some embodiments, during the time period ΔTΔT before a paging monitoring occasion (PO), the HD-FDD WD prioritizes DL reception of at least N number of RS (e.g., SSB reception, TRS reception) over UL transmission (e.g., random access or any other UL transmission). This allows the WD to perform resynchronization (time/frequency tracking) towards cell1 to be able to receive paging messages later in time in a PO starting from T2, where T2>T1. In this case, the WD is required to fulfill the paging requirements, i.e., does not miss the paging reception assuming sufficient radio conditions. Otherwise, DL measurement occasions during ΔTΔT cannot be guaranteed. Then the WD may be allowed to miss the paging reception in the PO starting from T2. In one example, N=1;
During the period ΔTΔT before the DL signal reception (e.g., paging) for the WD configured with DRX, the HD-FDD WD prioritizes reception of at least N number of SSBs over random access or any other UL transmission. Optionally, the WD prioritizes TRS reception over random access or any other UL transmission. In one example, N=1.

Some embodiments with S2 as RA signal may include one or more of the following:
In some embodiments, during the time period ΔT before a random access occasion (RO) in a target cell, the HD-FDD WD prioritizes DL reception of at least N number of RS (e.g., SSB reception, TRS reception) over UL transmission (e.g., random access or any other UL transmission) to allow the WD to perform resynchronization (time/frequency tracking) towards the target cell to be able to transmit later in time, the RO starting from T2, where T2>T1. In this case, the WD may be required to fulfill the RA requirements, i.e., so that it does not miss the RA transmission in the Rr starting from T2. Otherwise, i.e., if DL measurement occasions during ΔT cannot be guaranteed, then the WD may be allowed to miss or drop the RA transmission in the RO starting from T2. In one example, N=1.

According to one aspect, a wireless device, WD, configured to communicate with a network node in a half-duplex frequency division duplex, HD-FDD, mode is provided. The WD includes processing circuitry configured to determine whether a first signal reception, FSR, condition is met, the FSR condition including one of receipt and availability of at least N first signals during a time interval ΔT ending at a time T2, N being an integer greater than zero. The processing circuitry is further configured to, provided that the FSR condition is met, operate a second signal on a radio resource at the time T2.

According to this aspect, in some embodiments, the processing circuitry is further configured to prioritize downlink reception over uplink transmission during the time interval ΔT. In some embodiments, the processing circuitry is further configured to prioritize reception of a reference signal over transmission of a random access. In some embodiments, the second signal is a paging signal and the resource is a paging resource. In some embodiments, when the second signal is a downlink signal received by the WD, the second signal includes at least one of a paging signal and system information. In some embodiments, when the second signal is an uplink signal transmitted by the WD, the second signal includes at least one of a random access signal, a sounding reference signal, an msgA, an msg1 and an uplink transmission using configured grant-small data transmission (CG-SDT). In some embodiments, the second signal includes a paging signal and the processing circuitry is further configured to prioritize downlink reception of at least N first reference signals to enable synchronization between the WD and the network node prior to a paging occasion that starts at the time T2. In some embodiments, the FSR condition includes receiving at least N number of first signals during the time interval ΔT that have a bandwidth exceeding a first threshold. In some embodiments, the FSR condition includes receiving at least N2 first signals during the time interval ΔT that have a bandwidth that falls below a second threshold, N2 being an integer greater than 1. In some embodiments, the processing circuitry is further configured to select between two step random access and four-step random access when the FSR condition is met and the second signal is a random access signal. In some embodiments, the processing circuitry is further configured to refrain from selecting between two step random access and four-step random access when the FSR condition is not met. In some embodiments, the processing circuitry is further configured to perform a random access transmission in a physical random access channel, PRACH, occasion when the FSR condition is met. In some embodiments, when the FSR condition is not met, the processing circuitry is further configured to one of postpone, defer and delay operating the second signal. In some embodiments, when the FSR condition is not met, the processing circuitry is further configured to one of postpone, defer and delay operating the second signal until the FSR condition is met. In some embodiments, when the FSR condition is not met, the processing circuitry is further configured to one of discard and cancel operating the second signal. In some embodiments, when the FSR condition is not met, the processing circuitry is further configured to one of discard and cancel operating the second signal after M failed attempts to operate the second signal, M being an integer greater than zero. In some embodiments, when the WD is in a low-activity radio resource control, RRC state, the processing circuitry is further configured to re-synchronize with the network node and to perform automatic gain control during the time interval ΔT. In some embodiments, ΔT is determined based at least in part on one of a synchronization status of the WD, a discontinuous reception time, and a reference signal transmission periodicity. In some embodiments, operating the second signal includes receiving one of a paging signal, performing a random access procedure, and transmitting a small data transmission, SDT.

According to another aspect, a method in a wireless device, WD, configured to communicate with a network node in a half-duplex frequency division duplex, HD-FDD, mode is provided. The method includes determining whether a first signal reception, FSR, condition is met, the FSR condition including one of receipt and availability of at least N first signals during a time interval ΔT ending at a time T2, N being an integer greater than zero. The method also includes, provided that the FSR condition is met, operating a second signal on a radio resource at the time T2.

According to this aspect, in some embodiments, the method also includes prioritizing downlink reception over uplink transmission during the time interval ΔT. In some embodiments, the method also includes prioritizing reception of a reference signal over transmission of a random access. In some embodiments, the second signal is a paging signal and the resource is a paging resource. In some embodiments, when the second signal is a downlink signal received by the WD, the second signal includes at least one of a paging signal and system information. In some embodiments, when the second signal is an uplink signal transmitted by the WD, the second signal includes at least one of a random access signal, a sounding reference signal, an msgA, an msg1 and an uplink transmission using configured grant-small data transmission (CG-SDT). In some embodiments, the method includes, when the second signal includes a paging signal, prioritizing downlink reception of at least N first reference signals to enable synchronization between the WD and the network node prior to a paging occasion that starts at the time T2. In some embodiments, the FSR condition includes receiving at least N1 number of first signals during the time interval ΔT that have a bandwidth exceeding a first threshold. In some embodiments, the FSR condition includes receiving at least N2 first signals during the time interval ΔT that have a bandwidth that falls below a second threshold, N2 being an integer greater than 1. In some embodiments, the method also includes selecting between two step random access and four-step random access when the FSR condition is met and the second signal is a random access signal. In some embodiments, the method includes refraining from selecting between two step random access and four-step random access when the FSR condition is not met. In some embodiments, the method includes performing a random access transmission in a physical random access channel, PRACH, occasion when the FSR condition is met. In some embodiments, the method includes, when the FSR condition is not met, one of postponing, deferring and delaying operating the second signal. In some embodiments, the method includes, when the FSR condition is not met, one of postponing, deferring and delaying operating the second signal until the FSR condition is met. In some embodiments, the method includes, when the FSR condition is not met, one of discarding and canceling operating the second signal. In some embodiments, the method includes, when the FSR condition is not met, one of discarding and canceling operating the second signal after M failed attempts to operate the second signal, M being an integer greater than zero. In some embodiments, when the WD is in a low-activity radio resource control, RRC state, configuring the WD to re-synchronize with the network node and to perform automatic gain control during the time interval ΔT. In some embodiments, ΔT is determined based at least in part on one of a synchronization status of the WD, a discontinuous reception time, and a reference signal transmission periodicity. In some embodiments, operating the second signal includes receiving one of a paging signal, performing a random access procedure, and transmitting a small data transmission, SDT.

According to another aspect, a network node configured to communicate with a wireless device, WD, in a half-duplex frequency division duplex, HD-FDD, mode is provided. The network node includes a radio interface configured to transmit to the WD at least N first signals during the time interval ΔT ending at a time T2, N being an integer greater than zero. The network node includes processing circuitry in communication with the radio interface and configured to schedule uplink resources for uplink transmissions by the WD after the time T2, the uplink transmissions being responsive to one of receipt and availability of the at least N first signals during the time interval ΔT.

According to this aspect, in some embodiments, the processing circuitry is further configured to schedule at least one of a two-step random access and a four-step random access while avoiding overlapping synchronization signal resources and uplink resources in the time domain. In some embodiments, the time interval ΔT is greater than a synchronization signal periodicity plus a first switching time from uplink receipt to downlink transmission. In some embodiments, the processing circuitry is further configured to schedule the uplink resources during a time period between: a start of a synchronization signal minus the first switching time; and an end of the synchronization signal plus a second switching time from downlink transmission to uplink receipt. In some embodiments, the at least N first signals are synchronization signal and physical broadcast channel signal blocks, SSBs.

According to yet another aspect, a method in a network node configured to communicate with a wireless device, WD, in a half-duplex frequency division duplex, HD-FDD, mode is provided. The method includes transmitting to the WD at least N first signals during the time interval ΔT ending at a time T2, N being an integer greater than zero. The method includes scheduling uplink resources for uplink transmissions by the WD after the time T2, the uplink transmissions being responsive to one of receipt and availability of the at least N first signals during the time interval ΔT.

According to this aspect, in some embodiments, the method includes scheduling at least one of a two-step random access and a four-step random access while avoiding overlapping synchronization signal resources and uplink resources in the time domain. In some embodiments, the time interval ΔT is greater than a synchronization signal periodicity plus a first switching time from uplink receipt to downlink transmission. In some embodiments, the method includes scheduling the uplink resources during a time period between: a start of a synchronization signal minus the first switching time; and an end of the synchronization signal plus a second switching time from downlink transmission to uplink receipt. In some embodiments, the at least N first signals are synchronization signal and physical broadcast channel signal blocks, SSBs.

### BRIEF DESCRIPTION OF THE DRAWINGS

A more complete understanding of the present embodiments, and the attendant advantages and features thereof, will be more readily understood by reference to the following detailed description when considered in conjunction with the accompanying drawings wherein:

FIG. 1 illustrates a 4 step RA procedure;

FIG. 2 illustrates a 2 step RA procedure;

FIG. 3 is an example of DL/UL resources for a WD in IDLE/INACTIVE mode;

FIG. 4 is an example of DL/UL resources for a WD in CONNECTED mode DRX;

FIG. 5 is a schematic diagram of an example network architecture illustrating a communication system connected via an intermediate network to a host computer according to the principles in the present disclosure;

FIG. 6 is a block diagram of a host computer communicating via a network node with a wireless device over an at least partially wireless connection according to some embodiments of the present disclosure;

FIG. 7 is a flowchart illustrating example methods implemented in a communication system including a host computer, a network node and a wireless device for executing a client application at a wireless device according to some embodiments of the present disclosure;

FIG. 8 is a flowchart illustrating example methods implemented in a communication system including a host computer, a network node and a wireless device for receiving user data at a wireless device according to some embodiments of the present disclosure;

FIG. 9 is a flowchart illustrating example methods implemented in a communication system including a host computer, a network node and a wireless device for receiving user data from the wireless device at a host computer according to some embodiments of the present disclosure;

FIG. 10 is a flowchart illustrating example methods implemented in a communication system including a host computer, a network node and a wireless device for receiving user data at a host computer according to some embodiments of the present disclosure;

FIG. 11 is a flowchart of an example process in a wireless device for proactive (SSB)/(TRS) reception procedures for half-duplex operation;

FIG. 12 is a flowchart of another example process in a wireless device for proactive (SSB)/(TRS) reception procedures for half-duplex operation;

FIG. 13 is a flowchart of an example process in a network node for proactive (SSB)/(TRS) reception procedures for half-duplex operation;

FIG. 14 is an example of the WD operating N number of signals;

FIG. 15 illustrates an example where an SSB is scheduled with the periodicity T_{SSB};

FIG. 16 illustrates an example for DL measurement occasions;

FIG. 17 illustrates an example when the WD uses an SSB;

FIG. 18 illustrates an example where an SSB is scheduled with the periodicity T_{SSB};

FIG. 19 is an example of the SSB measurement prioritization before random access; and

FIG. 20 is an example of UL transmission after SSB measurements.

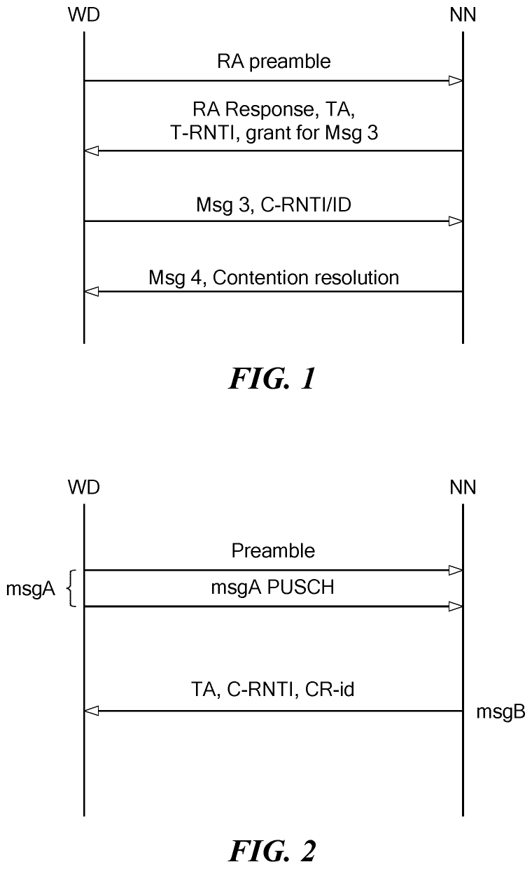

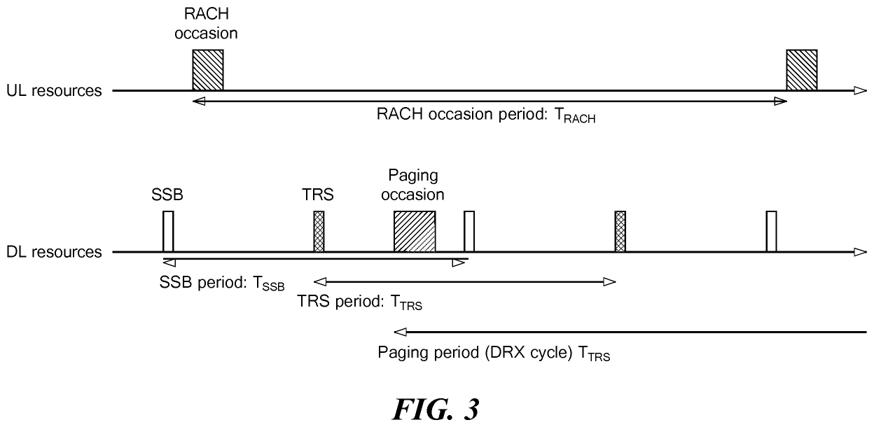

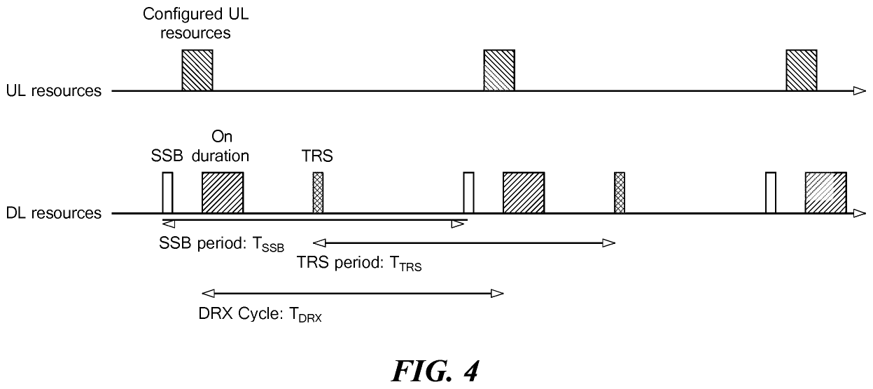

### DETAILED DESCRIPTION

Before describing in detail example embodiments, it is noted that the embodiments reside primarily in combinations of apparatus components and processing steps related to proactive (SSB)/(TRS) reception procedures for half-duplex operation. Accordingly, components have been represented where appropriate by conventional symbols in the drawings, showing only those specific details that are pertinent to understanding the embodiments so as not to obscure the disclosure with details that will be readily apparent to those of ordinary skill in the art having the benefit of the description herein. Like numbers refer to like elements throughout the description.

As used herein, relational terms, such as “first” and “second,” “top” and “bottom,” and the like, may be used solely to distinguish one entity or element from another entity or element without necessarily requiring or implying any physical or logical relationship or order between such entities or elements. The terminology used herein is for the purpose of describing particular embodiments only and is not intended to be limiting of the concepts described herein. As used herein, the singular forms “a”, “an” and “the” are intended to include the plural forms as well, unless the context clearly indicates otherwise. It will be further understood that the terms “comprises,” “comprising,” “includes” and/or “including” when used herein, specify the presence of stated features, integers, steps, operations, elements, and/or components, but do not preclude the presence or addition of one or more other features, integers, steps, operations, elements, components, and/or groups thereof.

In embodiments described herein, the joining term, “in communication with” and the like, may be used to indicate electrical or data communication, which may be accomplished by physical contact, induction, electromagnetic radiation, radio signaling, infrared signaling or optical signaling, for example. One having ordinary skill in the art will appreciate that multiple components may interoperate and modifications and variations are possible of achieving the electrical and data communication.

In some embodiments described herein, the term “coupled,” “connected,” and the like, may be used herein to indicate a connection, although not necessarily directly, and may include wired and/or wireless connections.

The term “network node” used herein may be any kind of network node comprised in a radio network which may further comprise any of base station (BS), radio base station, base transceiver station (BTS), base station controller (BSC), radio network controller (RNC), g Node B (gNB), evolved Node B (eNB or eNodeB), Node B, multi-standard radio (MSR) radio node such as MSR BS, multi-cell/multicast coordination entity (MCE), integrated access and backhaul (IAB) node, relay node, donor node controlling relay, radio access point (AP), transmission points, transmission nodes, Remote Radio Unit (RRU) Remote Radio Head (RRH), a core network node (e.g., mobile management entity (MME), self-organizing network (SON) node, a coordinating node, positioning node, MAT node, etc.), an external node (e.g., 3rd party node, a node external to the current network), nodes in distributed antenna system (DAS), a spectrum access system (SAS) node, an element management system (EMS), etc. The network node may also comprise test equipment. The term “radio node” used herein may be used to also denote a wireless device (WD) such as a wireless device (WD) or a radio network node.

In some embodiments, the non-limiting terms wireless device (WD) or a user equipment (UE) are used interchangeably. The WD herein may be any type of wireless device capable of communicating with a network node or another WD over radio signals, such as wireless device (WD). The WD may also be a radio communication device, target device, device to device (D2D) WD, machine type WD or WD capable of machine to machine communication (M2M), low-cost and/or low-complexity WD, a sensor equipped with WD, Tablet, mobile terminals, smart phone, laptop embedded equipped (LEE), laptop mounted equipment (LME), USB dongles, Customer Premises Equipment (CPE), an Internet of Things (IoT) device, or a Narrowband IoT (NB-IOT) device, etc.

Also, in some embodiments the generic term “radio network node” is used. It may be any kind of a radio network node which may comprise any of base station, radio base station, base transceiver station, base station controller, network controller, RNC, evolved Node B (eNB), Node B, gNB, Multi-cell/multicast Coordination Entity (MCE), IAB node, relay node, access point, radio access point, Remote Radio Unit (RRU) Remote Radio Head (RRH).

Note that although terminology from one particular wireless system, such as, for example, 3GPP LTE and/or New Radio (NR), may be used in this disclosure, this should not be seen as limiting the scope of the disclosure to only the aforementioned system. Other wireless systems, including without limitation Wide Band Code Division Multiple Access (WCDMA), Worldwide Interoperability for Microwave Access (WiMax), Ultra Mobile Broadband (UMB) and Global System for Mobile Communications (GSM), may also benefit from exploiting the ideas covered within this disclosure.

Note further, that functions described herein as being performed by a wireless device or a network node may be distributed over a plurality of wireless devices and/or network nodes. In other words, it is contemplated that the functions of the network node and wireless device described herein are not limited to performance by a single physical device and, in fact, may be distributed among several physical devices.

Unless otherwise defined, all terms (including technical and scientific terms) used herein have the same meaning as commonly understood by one of ordinary skill in the art to which this disclosure belongs. It will be further understood that terms used herein should be interpreted as having a meaning that is consistent with their meaning in the context of this specification and the relevant art and will not be interpreted in an idealized or overly formal sense unless expressly so defined herein.

Some embodiments provide proactive (SSB)/(TRS) reception procedures for half-duplex operation.

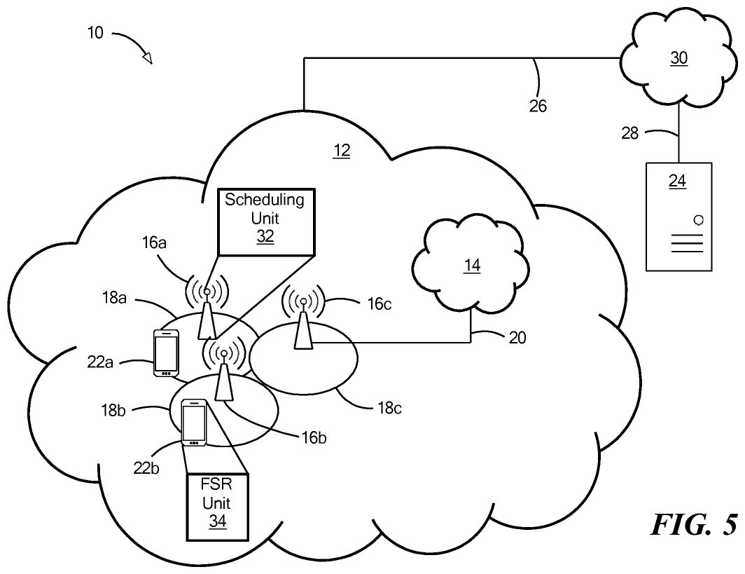

Referring again to the drawing figures, in which like elements are referred to by like reference numerals, there is shown in FIG. 5 a schematic diagram of a communication system 10, according to an embodiment, such as a 3GPP-type cellular network that may support standards such as LTE and/or NR (5G), which comprises an access network 12, such as a radio access network, and a core network 14. The access network 12 comprises a plurality of network nodes 16a, 16b, 16c (referred to collectively as network nodes 16), such as NBs, eNBs, gNBs or other types of wireless access points, each defining a corresponding coverage area 18a, 18b, 18c (referred to collectively as coverage areas 18). Each network node 16a, 16b, 16c is connectable to the core network 14 over a wired or wireless connection 20. A first wireless device (WD) 22a located in coverage area 18a is configured to wirelessly connect to, or be paged by, the corresponding network node 16a. A second WD 22b in coverage area 18b is wirelessly connectable to the corresponding network node 16b. While a plurality of WDs 22a, 22b (collectively referred to as wireless devices 22) are illustrated in this example, the disclosed embodiments are equally applicable to a situation where a sole WD is in the coverage area or where a sole WD is connecting to the corresponding network node 16. Note that although only two WDs 22 and three network nodes 16 are shown for convenience, the communication system may include many more WDs 22 and network nodes 16.

Also, it is contemplated that a WD 22 may be in simultaneous communication and/or configured to separately communicate with more than one network node 16 and more than one type of network node 16. For example, a WD 22 can have dual connectivity with a network node 16 that supports LTE and the same or a different network node 16 that supports NR. As an example, WD 22 may be in communication with an eNB for LTE/E-UTRAN and a gNB for NR/NG-RAN.

The communication system 10 may itself be connected to a host computer 24, which may be embodied in the hardware and/or software of a standalone server, a cloud-implemented server, a distributed server or as processing resources in a server farm. The host computer 24 may be under the ownership or control of a service provider, or may be operated by the service provider or on behalf of the service provider. The connections 26, 28 between the communication system 10 and the host computer 24 may extend directly from the core network 14 to the host computer 24 or may extend via an optional intermediate network 30. The intermediate network 30 may be one of, or a combination of more than one of, a public, private or hosted network. The intermediate network 30, if any, may be a backbone network or the Internet. In some embodiments, the intermediate network 30 may comprise two or more sub-networks (not shown).

The communication system of FIG. 5 as a whole enables connectivity between one of the connected WDs 22a, 22b and the host computer 24. The connectivity may be described as an over-the-top (OTT) connection. The host computer 24 and the connected WDs 22a, 22b are configured to communicate data and/or signaling via the OTT connection, using the access network 12, the core network 14, any intermediate network 30 and possible further infrastructure (not shown) as intermediaries. The OTT connection may be transparent in the sense that at least some of the participating communication devices through which the OTT connection passes are unaware of routing of uplink and downlink communications. For example, a network node 16 may not or need not be informed about the past routing of an incoming downlink communication with data originating from a host computer 24 to be forwarded (e.g., handed over) to a connected WD 22a. Similarly, the network node 16 need not be aware of the future routing of an outgoing uplink communication originating from the WD 22a towards the host computer 24.

A network node is configured to include a scheduling unit 32 which is configured to schedule uplink resources for uplink transmissions by the WD after the time T2, the uplink transmissions being responsive to one of receipt and availability of the at least N first signals during the time interval ΔT. A wireless device 22 is configured to include an FSR unit 34 configured to determine whether a first signal reception, FSR, condition is met, the FSR condition including one of receipt and availability of at least N first signals during a time interval ΔT ending at a time T2, N being an integer greater than zero.

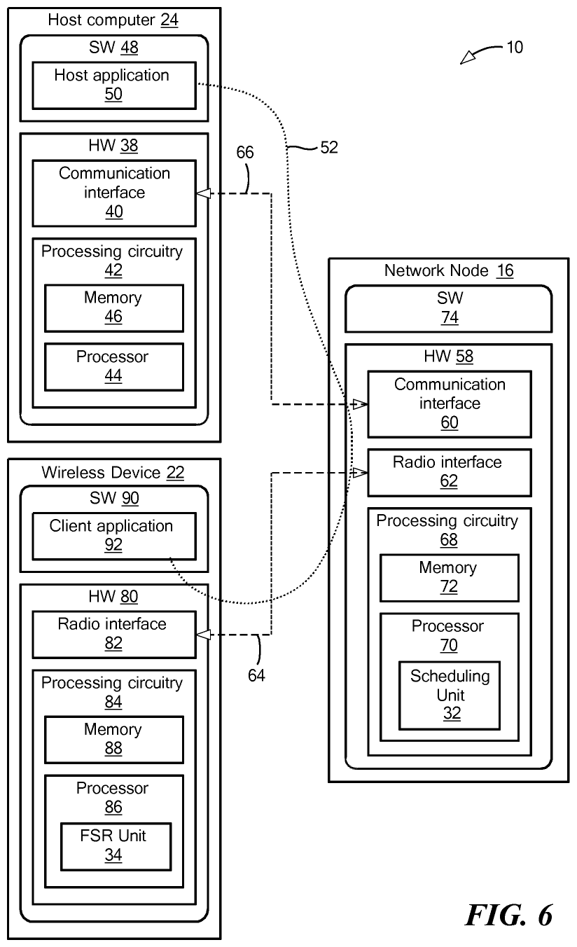

Example implementations, in accordance with an embodiment, of the WD 22, network node 16 and host computer 24 discussed in the preceding paragraphs will now be described with reference to FIG. 6. In a communication system 10, a host computer 24 comprises hardware (HW) 38 including a communication interface 40 configured to set up and maintain a wired or wireless connection with an interface of a different communication device of the communication system 10. The host computer 24 further comprises processing circuitry 42, which may have storage and/or processing capabilities. The processing circuitry 42 may include a processor 44 and memory 46. In particular, in addition to or instead of a processor, such as a central processing unit, and memory, the processing circuitry 42 may comprise integrated circuitry for processing and/or control, e.g., one or more processors and/or processor cores and/or FPGAs (Field Programmable Gate Array) and/or ASICs (Application Specific Integrated Circuitry) adapted to execute instructions. The processor 44 may be configured to access (e.g., write to and/or read from) memory 46, which may comprise any kind of volatile and/or nonvolatile memory, e.g., cache and/or buffer memory and/or RAM (Random Access Memory) and/or ROM (Read-Only Memory) and/or optical memory and/or EPROM (Erasable Programmable Read-Only Memory).

Processing circuitry 42 may be configured to control any of the methods and/or processes described herein and/or to cause such methods, and/or processes to be performed, e.g., by host computer 24. Processor 44 corresponds to one or more processors 44 for performing host computer 24 functions described herein. The host computer 24 includes memory 46 that is configured to store data, programmatic software code and/or other information described herein. In some embodiments, the software 48 and/or the host application 50 may include instructions that, when executed by the processor 44 and/or processing circuitry 42, causes the processor 44 and/or processing circuitry 42 to perform the processes described herein with respect to host computer 24. The instructions may be software associated with the host computer 24.

The software 48 may be executable by the processing circuitry 42. The software 48 includes a host application 50. The host application 50 may be operable to provide a service to a remote user, such as a WD 22 connecting via an OTT connection 52 terminating at the WD 22 and the host computer 24. In providing the service to the remote user, the host application 50 may provide user data which is transmitted using the OTT connection 52. The “user data” may be data and information described herein as implementing the described functionality. In one embodiment, the host computer 24 may be configured for providing control and functionality to a service provider and may be operated by the service provider or on behalf of the service provider. The processing circuitry 42 of the host computer 24 may enable the host computer 24 to observe, monitor, control, transmit to and/or receive from the network node 16 and or the wireless device 22.

The communication system 10 further includes a network node 16 provided in a communication system 10 and including hardware 58 enabling it to communicate with the host computer 24 and with the WD 22. The hardware 58 may include a communication interface 60 for setting up and maintaining a wired or wireless connection with an interface of a different communication device of the communication system 10, as well as a radio interface 62 for setting up and maintaining at least a wireless connection 64 with a WD 22 located in a coverage area 18 served by the network node 16. The radio interface 62 may be formed as or may include, for example, one or more RF transmitters, one or more RF receivers, and/or one or more RF transceivers. The communication interface 60 may be configured to facilitate a connection 66 to the host computer 24. The connection 66 may be direct or it may pass through a core network 14 of the communication system 10 and/or through one or more intermediate networks 30 outside the communication system 10.

In the embodiment shown, the hardware 58 of the network node 16 further includes processing circuitry 68. The processing circuitry 68 may include a processor 70 and a memory 72. In particular, in addition to or instead of a processor, such as a central processing unit, and memory, the processing circuitry 68 may comprise integrated circuitry for processing and/or control, e.g., one or more processors and/or processor cores and/or FPGAs (Field Programmable Gate Array) and/or ASICs (Application Specific Integrated Circuitry) adapted to execute instructions. The processor 70 may be configured to access (e.g., write to and/or read from) the memory 72, which may comprise any kind of volatile and/or nonvolatile memory, e.g., cache and/or buffer memory and/or RAM (Random Access Memory) and/or ROM (Read-Only Memory) and/or optical memory and/or EPROM (Erasable Programmable Read-Only Memory).

Thus, the network node 16 further has software 74 stored internally in, for example, memory 72, or stored in external memory (e.g., database, storage array, network storage device, etc.) accessible by the network node 16 via an external connection. The software 74 may be executable by the processing circuitry 68. The processing circuitry 68 may be configured to control any of the methods and/or processes described herein and/or to cause such methods, and/or processes to be performed, e.g., by network node 16. Processor 70 corresponds to one or more processors 70 for performing network node 16 functions described herein. The memory 72 is configured to store data, programmatic software code and/or other information described herein. In some embodiments, the software 74 may include instructions that, when executed by the processor 70 and/or processing circuitry 68, causes the processor 70 and/or processing circuitry 68 to perform the processes described herein with respect to network node 16. In some embodiments the processing circuitry 68 and/or processor may include a scheduling unit 32 which is configured to schedule uplink resources for uplink transmissions by the WD after the time T2, the uplink transmissions being responsive to one of receipt and availability of the at least N first signals during the time interval ΔT.

The communication system 10 further includes the WD 22 already referred to. The WD 22 may have hardware 80 that may include a radio interface 82 configured to set up and maintain a wireless connection 64 with a network node 16 serving a coverage area 18 in which the WD 22 is currently located. The radio interface 82 may be formed as or may include, for example, one or more RF transmitters, one or more RF receivers, and/or one or more RF transceivers.

The hardware 80 of the WD 22 further includes processing circuitry 84. The processing circuitry 84 may include a processor 86 and memory 88. In particular, in addition to or instead of a processor, such as a central processing unit, and memory, the processing circuitry 84 may comprise integrated circuitry for processing and/or control, e.g., one or more processors and/or processor cores and/or FPGAs (Field Programmable Gate Array) and/or ASICs (Application Specific Integrated Circuitry) adapted to execute instructions. The processor 86 may be configured to access (e.g., write to and/or read from) memory 88, which may comprise any kind of volatile and/or nonvolatile memory, e.g., cache and/or buffer memory and/or RAM (Random Access Memory) and/or ROM (Read-Only Memory) and/or optical memory and/or EPROM (Erasable Programmable Read-Only Memory).

Thus, the WD 22 may further comprise software 90, which is stored in, for example, memory 88 at the WD 22, or stored in external memory (e.g., database, storage array, network storage device, etc.) accessible by the WD 22. The software 90 may be executable by the processing circuitry 84. The software 90 may include a client application 92. The client application 92 may be operable to provide a service to a human or non-human user via the WD 22, with the support of the host computer 24. In the host computer 24, an executing host application 50 may communicate with the executing client application 92 via the OTT connection 52 terminating at the WD 22 and the host computer 24. In providing the service to the user, the client application 92 may receive request data from the host application 50 and provide user data in response to the request data. The OTT connection 52 may transfer both the request data and the user data. The client application 92 may interact with the user to generate the user data that it provides.

The processing circuitry 84 may be configured to control any of the methods and/or processes described herein and/or to cause such methods, and/or processes to be performed, e.g., by WD 22. The processor 86 corresponds to one or more processors 86 for performing WD 22 functions described herein. The WD 22 includes memory 88 that is configured to store data, programmatic software code and/or other information described herein. In some embodiments, the software 90 and/or the client application 92 may include instructions that, when executed by the processor 86 and/or processing circuitry 84, causes the processor 86 and/or processing circuitry 84 to perform the processes described herein with respect to WD 22. For example, the processing circuitry 84 of the wireless device 22 may include an FSR unit 34 configured to determine whether a first signal reception, FSR, condition is met, the FSR condition including one of receipt and availability of at least N first signals during a time interval ΔT ending at a time T2, N being an integer greater than zero.

In some embodiments, the inner workings of the network node 16, WD 22, and host computer 24 may be as shown in FIG. 6 and independently, the surrounding network topology may be that of FIG. 5.

In FIG. 6, the OTT connection 52 has been drawn abstractly to illustrate the communication between the host computer 24 and the wireless device 22 via the network node 16, without explicit reference to any intermediary devices and the precise routing of messages via these devices. Network infrastructure may determine the routing, which it may be configured to hide from the WD 22 or from the service provider operating the host computer 24, or both. While the OTT connection 52 is active, the network infrastructure may further take decisions by which it dynamically changes the routing (e.g., on the basis of load balancing consideration or reconfiguration of the network).

The wireless connection 64 between the WD 22 and the network node 16 is in accordance with the teachings of the embodiments described throughout this disclosure. One or more of the various embodiments improve the performance of OTT services provided to the WD 22 using the OTT connection 52, in which the wireless connection 64 may form the last segment. More precisely, the teachings of some of these embodiments may improve the data rate, latency, and/or power consumption and thereby provide benefits such as reduced user waiting time, relaxed restriction on file size, better responsiveness, extended battery lifetime, etc.

In some embodiments, a measurement procedure may be provided for the purpose of monitoring data rate, latency and other factors on which the one or more embodiments improve. There may further be an optional network functionality for reconfiguring the OTT connection 52 between the host computer 24 and WD 22, in response to variations in the measurement results. The measurement procedure and/or the network functionality for reconfiguring the OTT connection 52 may be implemented in the software 48 of the host computer 24 or in the software 90 of the WD 22, or both. In embodiments, sensors (not shown) may be deployed in or in association with communication devices through which the OTT connection 52 passes; the sensors may participate in the measurement procedure by supplying values of the monitored quantities exemplified above, or supplying values of other physical quantities from which software 48, 90 may compute or estimate the monitored quantities. The reconfiguring of the OTT connection 52 may include message format, retransmission settings, preferred routing etc.; the reconfiguring need not affect the network node 16, and it may be unknown or imperceptible to the network node 16. Some such procedures and functionalities may be known and practiced in the art. In certain embodiments, measurements may involve proprietary WD signaling facilitating the host computer's 24 measurements of throughput, propagation times, latency and the like. In some embodiments, the measurements may be implemented in that the software 48, 90 causes messages to be transmitted, in particular empty or ‘dummy’ messages, using the OTT connection 52 while it monitors propagation times, errors, etc.

Thus, in some embodiments, the host computer 24 includes processing circuitry 42 configured to provide user data and a communication interface 40 that is configured to forward the user data to a cellular network for transmission to the WD 22. In some embodiments, the cellular network also includes the network node 16 with a radio interface 62. In some embodiments, the network node 16 is configured to, and/or the network node's 16 processing circuitry 68 is configured to perform the functions and/or methods described herein for preparing/initiating/maintaining/supporting/ending a transmission to the WD 22, and/or preparing/terminating/maintaining/supporting/ending in receipt of a transmission from the WD 22.

In some embodiments, the host computer 24 includes processing circuitry 42 and a communication interface 40 that is configured to a communication interface 40 configured to receive user data originating from a transmission from a WD 22 to a network node 16. In some embodiments, the WD 22 is configured to, and/or comprises a radio interface 82 and/or processing circuitry 84 configured to perform the functions and/or methods described herein for preparing/initiating/maintaining/supporting/ending a transmission to the network node 16, and/or preparing/terminating/maintaining/supporting/ending in receipt of a transmission from the network node 16.

Although FIGS. 5 and 6 show various “units” such as, and scheduling unit 32 and FSR unit 34 as being within a respective processor, it is contemplated that these units may be implemented such that a portion of the unit is stored in a corresponding memory within the processing circuitry. In other words, the units may be implemented in hardware or in a combination of hardware and software within the processing circuitry.

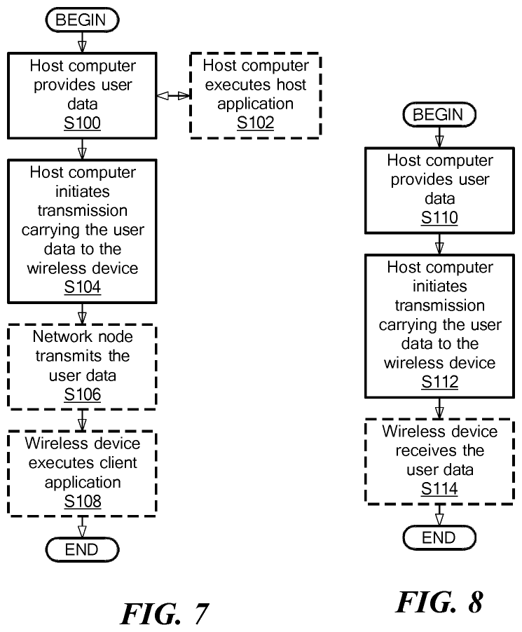

FIG. 7 is a flowchart illustrating an example method implemented in a communication system, such as, for example, the communication system of FIGS. 5 and 6, in accordance with one embodiment. The communication system may include a host computer 24, a network node 16 and a WD 22, which may be those described with reference to FIG. 6. In a first step of the method, the host computer 24 provides user data (Block S100). In an optional substep of the first step, the host computer 24 provides the user data by executing a host application, such as, for example, the host application 50 (Block S102). In a second step, the host computer 24 initiates a transmission carrying the user data to the WD 22 (Block S104). In an optional third step, the network node 16 transmits to the WD 22 the user data which was carried in the transmission that the host computer 24 initiated, in accordance with the teachings of the embodiments described throughout this disclosure (Block S106). In an optional fourth step, the WD 22 executes a client application, such as, for example, the client application 92, associated with the host application 50 executed by the host computer 24 (Block S108).

FIG. 8 is a flowchart illustrating an example method implemented in a communication system, such as, for example, the communication system of FIG. 5, in accordance with one embodiment. The communication system may include a host computer 24, a network node 16 and a WD 22, which may be those described with reference to FIGS. 5 and 6. In a first step of the method, the host computer 24 provides user data (Block S110). In an optional substep (not shown) the host computer 24 provides the user data by executing a host application, such as, for example, the host application 50. In a second step, the host computer 24 initiates a transmission carrying the user data to the WD 22 (Block S112). The transmission may pass via the network node 16, in accordance with the teachings of the embodiments described throughout this disclosure. In an optional third step, the WD 22 receives the user data carried in the transmission (Block S114).

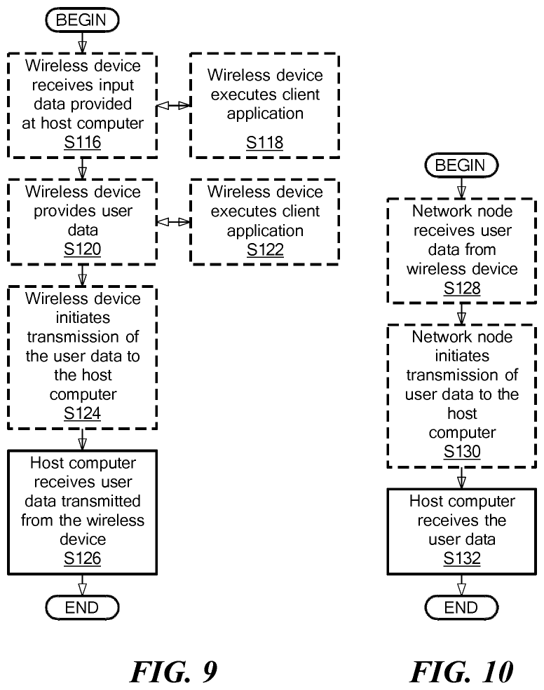

FIG. 9 is a flowchart illustrating an example method implemented in a communication system, such as, for example, the communication system of FIG. 5, in accordance with one embodiment. The communication system may include a host computer 24, a network node 16 and a WD 22, which may be those described with reference to FIGS. 5 and 6. In an optional first step of the method, the WD 22 receives input data provided by the host computer 24 (Block S116). In an optional substep of the first step, the WD 22 executes the client application 92, which provides the user data in reaction to the received input data provided by the host computer 24 (Block S118). Additionally or alternatively, in an optional second step, the WD 22 provides user data (Block S120). In an optional substep of the second step, the WD provides the user data by executing a client application, such as, for example, client application 92 (Block S122). In providing the user data, the executed client application 92 may further consider user input received from the user. Regardless of the specific manner in which the user data was provided, the WD 22 may initiate, in an optional third substep, transmission of the user data to the host computer 24 (Block S124). In a fourth step of the method, the host computer 24 receives the user data transmitted from the WD 22, in accordance with the teachings of the embodiments described throughout this disclosure (Block S126).

FIG. 10 is a flowchart illustrating an example method implemented in a communication system, such as, for example, the communication system of FIG. 5, in accordance with one embodiment. The communication system may include a host computer 24, a network node 16 and a WD 22, which may be those described with reference to FIGS. 5 and 6. In an optional first step of the method, in accordance with the teachings of the embodiments described throughout this disclosure, the network node 16 receives user data from the WD 22 (Block S128). In an optional second step, the network node 16 initiates transmission of the received user data to the host computer 24 (Block S130). In a third step, the host computer 24 receives the user data carried in the transmission initiated by the network node 16 (Block S132).

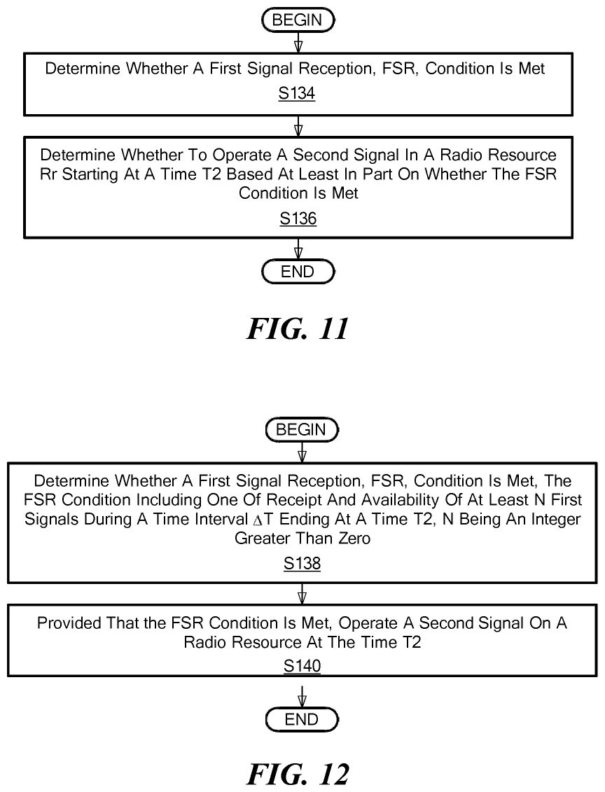

FIG. 11 is a flowchart of an example process in a wireless device 22 according to some embodiments of the present disclosure. One or more blocks described herein may be performed by one or more elements of wireless device 22 such as by one or more of processing circuitry 84 (including the FSR unit 34), processor 86, radio interface 82 and/or communication interface 60. Wireless device 22 is configured to determine whether a first signal reception, FSR, condition is met (Block S134). The process also includes determining whether to operate a second signal in a radio resource Rr starting at a time T2 based at least in part on whether the FSR condition is met (Block S136).

FIG. 12 is a flowchart of an example process in a wireless device 22 according to some embodiments of the present disclosure. One or more blocks described herein may be performed by one or more elements of wireless device 22 such as by one or more of processing circuitry 84 (including the FSR unit 34), processor 86, radio interface 82 and/or communication interface 60. Wireless device 22 is configured to determine whether a first signal reception, FSR, condition is met, the FSR condition including one of receipt and availability of at least N first signals during a time interval ΔT ending at a time T2, N being an integer greater than zero (Block S138). The process also includes, provided that the FSR condition is met, operating a second signal on a radio resource at the time T2 (Block S140).

In some embodiments, the method also includes prioritizing downlink reception over uplink transmission during the time interval ΔT. In some embodiments, the method also includes prioritizing reception of a reference signal over transmission of a random access. In some embodiments, the second signal is a paging signal and the resource is a paging resource. In some embodiments, when the second signal is a downlink signal received by the WD 22, the second signal includes at least one of a paging signal and system information. In some embodiments, when the second signal is an uplink signal transmitted by the WD 22, the second signal includes at least one of a random access signal, a sounding reference signal, an msgA, an msg1 and an uplink transmission using configured grant-small data transmission (CG-SDT). In some embodiments, the method includes, when the second signal includes a paging signal, prioritizing downlink reception of at least N first reference signals to enable synchronization between the WD 22 and the network node prior to a paging occasion that starts at the time T2. In some embodiments, the FSR condition includes receiving at least N1 number of first signals during the time interval ΔT that have a bandwidth exceeding a first threshold. In some embodiments, the FSR condition includes receiving at least N2 first signals during the time interval ΔT that have a bandwidth that falls below a second threshold, N2 being an integer greater than 1. In some embodiments, the method also includes selecting between two step random access and four-step random access when the FSR condition is met and the second signal is a random access signal. In some embodiments, the method includes refraining from selecting between two step random access and four-step random access when the FSR condition is not met. In some embodiments, the method includes performing a random access transmission in a physical random access channel, PRACH, occasion when the FSR condition is met. In some embodiments, the method includes, when the FSR condition is not met, one of postponing, deferring and delaying operating the second signal. In some embodiments, the method includes, when the FSR condition is not met, one of postponing, deferring and delaying operating the second signal until the FSR condition is met. In some embodiments, the method includes, when the FSR condition is not met, one of discarding and canceling operating the second signal. In some embodiments, the method includes, when the FSR condition is not met, one of discarding and canceling operating the second signal after M failed attempts to operate the second signal, M being an integer greater than zero. In some embodiments, when the WD 22 is in a low-activity radio resource control, RRC state, configuring the WD 22 to re-synchronize with the network node and to perform automatic gain control during the time interval ΔT. In some embodiments, ΔT is determined based at least in part on one of a synchronization status of the WD 22, a discontinuous reception time, and a reference signal transmission periodicity. In some embodiments, operating the second signal includes receiving one of a paging signal, performing a random access procedure, and transmitting a small data transmission, SDT.

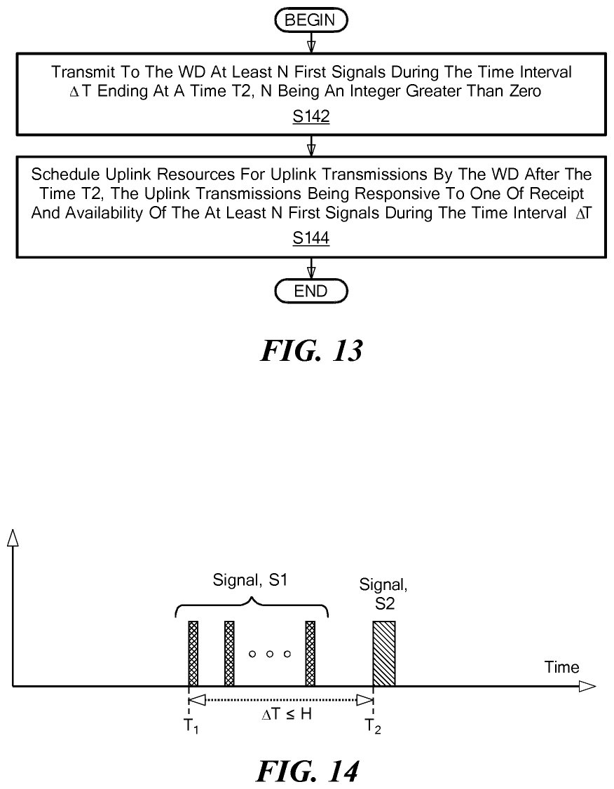

FIG. 13 is a flowchart of an example process in a network node 16 for rank restriction for multi-panel uplink (UL) transmission. One or more blocks described herein may be performed by one or more elements of network node 16 such as by one or more of processing circuitry 68 (including the scheduling unit 32), processor 70, radio interface 62 and/or communication interface 60. Network node 16 may be configured to transmit to the WD 22 at least N first signals during the time interval ΔT ending at a time T2, N being an integer greater than zero (Block S142). The process also includes scheduling uplink resources for uplink transmissions by the WD 22 after the time T2, the uplink transmissions being responsive to one of receipt and availability of the at least N first signals during the time interval ΔT (Block S144). In some embodiments, the method includes scheduling at least one of a two-step random access and a four-step random access while avoiding overlapping synchronization signal resources and uplink resources in the time domain. In some embodiments, the time interval ΔT is greater than a synchronization signal periodicity plus a first switching time from uplink receipt to downlink transmission. In some embodiments, the method includes scheduling the uplink resources during a time period between: a start of a synchronization signal minus the first switching time; and an end of the synchronization signal plus a second switching time from downlink transmission to uplink receipt. In some embodiments, the at least N first signals are synchronization signal and physical broadcast channel signal blocks, SSBs.

Having described the general process flow of arrangements of the disclosure and having provided examples of hardware and software arrangements for implementing the processes and functions of the disclosure, the sections below provide details and examples of arrangements for proactive (SSB)/(TRS) reception procedures for half-duplex operation.

In the following embodiments, solutions are described using generic terms for DL reception or DL signal reception and UL transmission or UL signal transmission. DL reception can include reception of one or more DL signals. Examples of DL signals are physical DL channels and DL physical signals. The physical channel (DL or UL) may carry higher layer information e.g., control, data, etc. Examples of DL physical channels are PDSCH, PDCCH, PBCH, CORSET, etc. Examples of physical signals (DL or UL) are reference signals (may also be called as pilot signals, training sequence, etc.). Examples of DL RS are PSS, SSS, SSB, CSI-RS, PRS, TRS, DMRS, reference signals (e.g., PSS, SSS, DMRS) within SSB, etc. Similarly, UL transmission can include physical UL channels or signals. Examples of UL physical channels are PUSCH, PUCCH, SR etc. Examples of UL RSs are DMRS, SRS, etc. When DL reception or UL transmission is described as being dynamically scheduled or semi-statically configured, all the mentioned physical channels and signals may be covered.

The term time resource used herein may correspond to any type of physical resource or radio resource expressed in terms of length of time. Examples of time resources are: symbol, sub-slot, mini-slot, time slot, subframe, radio frame, transmission time interval (TTI), interleaving time, frame, system frame number (SFN) cycle, hyper-SFN (H-SFN) cycle, etc.

Some embodiments are intended for NR HD-FDD capable WDs. An example of a NR HD-FDD capable WD 22 is a NR HD-FDD Type-A WD. They provide WD behavior in handling DL/UL collision for HD-FDD WDs. However, the solutions are not necessarily restricted to HD-FDD WDs.

In the following sections the term dropping reception of a signal may imply that the WD 22 does not receive the signal. The term dropping transmission of a signal may imply that the WD 22 does not transmit the signal. The term dropping signal reception may also interchangeably be called cancelling, discarding, abandoning, stopping reception of the signal, not receiving the signal, etc. Similarly, the term dropping signal transmission may also interchangeably be called cancelling, discarding, abandoning, stopping transmission of the signal, not transmitting the signal, etc.

Some embodiments are applicable to a WD 22 configured in HD-FDD mode and served by at least one cell, a first cell (cell1). The WD 22 may be configured to operate at least one second signal (S2) in a radio resource (Rr) starting at a time instance, T2, in a cell. The cell may be cell1 or another cell, e.g., a second cell (cell2). The operation of S2 may include the WD 22 performing one or more of: receiving S2 and transmitting S2. In order to operate S2, or prior to operating S2, the WD 22 may receive a first signal (S1) in a cell (e.g., cell1 or cell2).

In some embodiments, the WD 22 is configured to operate the signal, S2, in the resource, Rr, and may perform the following steps:
Determine whether a first signal reception (FSR) condition is met by the WD 22;
Operate S2 in Rr based on whether the FSR is met by the WD 22;
If the WD 22 fulfils at least one FSR condition, then the WD 22 is expected to operate or it can operate or is required to operate S2 in the resource Rr starting at T2. Otherwise, the WD 22 is not expected to operate or is not required to operate or may not operate S2 in the resource Rr.

First Signal Reception (FSR) is determined by the WD 22 based on one or more rules, which may be pre-defined or configured by the network node 16.

Examples of rules may include the following:
In one example of the rule, the WD 22 meets FSR provided that the WD 22 can receive or has received at least N number of a first signal (S1) during a time period (ΔT) before T2 or between time instances T1 and T2; where ΔT=(T2−T1) and T1<T2 e.g., T1 is the time instance occurring before T2. The time period ΔT may be pre-defined, configured by the network node 16 or determined by the WD 22 autonomously. The time period ΔT may depend on S1 and/or S2 configuration parameters e.g., their periodicities etc. In one example, N=1. In another example, N>1 e.g., N=4;
In another example of the rule, the WD 22 meets FSR provided that the WD 22 can receive or has received at least N number of S1 each with bandwidth (BW) that is larger than or equal to a threshold (Hb) during a ΔT before T2 or between time instances T1 and T2. N may further depend on the BW. Example of Hb is 48× subcarrier spacing (SCS), where SCS is the subcarrier scaping, e.g., 15 kHz, 30 kHz;

In another example of the rule, the WD 22 meets FSR provided that the WD 22 can receive or has received at least N1 number of S1 each with BW≥Hb or can receive at least N2 number of S1 if BW of at least one S1 is less than Hb during a time period (ΔT) before T2 or between time instances T1 and T2. N1 and N2 are different. In one example, N1<N2. N1 and N2 may further depends on the BW. Example of Hb is 48×SCS, where SCS is the subcarrier scaping, e.g., 15 kHz, 30 KHz.

The parameters T1, T2 and ΔT may be pre-defined, configured by the network node 16 or autonomously determined by the WD 22. In one example, the WD 22 may receive S1 in the same cell in which it operates S2 e.g., both signals in cell1, or both signals in cell2. In another example, the WD 22 may receive S1 in one cell while it may operate S2 in another cell e.g., signals S1 and S2 in cell1 and cell2 respectively, or signals S1 and S2 in cell2 and cell1 respectively.

In the above examples the rules may be phrased as follows:
“ . . . UE can receive or has received at least N number of S1 . . . ”, may also be referred to as, “ . . . at least N number of S1 is available or was available at the UE . . . ”.
“ . . . UE can receive or has received at least N number of S1 each of BW≥Hb . . . ”, may also be referred to as, “ . . . at least N number of S1 each with BW≥Hb is available or was available at the UE . . . ”.
“ . . . UE can receive or has received at least N1 number of S1 each with BW≥Hb or can receive at least N2 number if BW of at least one S1<Hb . . . ”, may also be referred to as, “ . . . at least N1 number of S1 each with BW≥Hb is available or was available at the UE . . . ”.

The N or N1 or N2 number of S1 may refer to instances of signal S1. Each instance may correspond to a time and/or frequency resource e.g., one or more time resources, resource blocks etc. In order to be able to receive the signal, S1, the WD 22 needs to turn on its receiver i.e., operate in DL reception mode. For example, if the WD 22 is configured in UL transmission (or configured UL resources) in T2, then the WD 22 may change or switch its transceiver to the DL reception mode at least during the N instances (e.g., time and/or frequency resources) to be able to receive at least N number of S1 between T2 and T1. However, in between the radio resources containing S1, the WD 22 may be in either operating mode (DL or UL). The WD 22 may switch to DL reception mode autonomously, based on a pre-defined rule or based on a message received from the network node 16.

The WD 22 may be required to meet FSR conditions to operate S2, so that the WD 22 transceiver is ready or tuned for operating S2. Therefore, the WD 22 may use at least N number of S1 to perform one or more radio preparatory operations or procedures. Examples of radio preparatory procedures are automatic gain control (AGC) setting or AGC settling, time tracking or synchronization, frequency tracking or synchronization, automatic frequency correction (AFC) etc.

In one example, the WD 22 may be configured such that the WD 22 may have to operate S2 in Rr starting from T2. In this case, the WD 22 may receive at least N1 number of S1 between T2 and T1. In another example, the WD 22 may be configured with the resources to operate S2 in Rr starting from T2. But whether the WD 22 may operate S2 in Rr may depend on one or more triggering conditions even if the WD 22 meets at least one FSR condition. Examples of triggering conditions are WD 22 losing synchronization with the cell e.g., cell1, the WD 22 needs to acquire grant or resources, etc.

If the WD 22 does not operate S2 due to not meeting the at least one FSR condition, then the WD 22 may further perform one or more tasks or procedures or actions. Examples of such tasks are:
Postponing, deferring or delaying the operation of S2 at a later time e.g., checking again the FRS condition later and transmitting S2 after T2 in another radio resource if the FSR condition is met;
Discarding or canceling the operation of S2 after M number of fail attempts to operate S2. In one example M=1 and in another example M>1. M may be pre-defined or configured by the network node 16.

Examples of S1 include reference signals (RS) e.g., PSS, SSS, SSB, CSI-RS, DMRS, PRS, etc.

Examples of S2 signals in DL operation includes paging, system information (SI) (e.g., SIB1, SIB2, etc.).

Examples of S2 signals in UL operation include random access (RA), PUSCH, PUCCH, CG-SΔT transmission resource, SRS, msgA, msg1, etc.

The above general concept is now described with several specific examples of different specific combinations of S1 and S2.

FIG. 12 is an example of the WD 22 operating N number of signals, S1 (e.g., N number of SSBs), within ΔT (ΔT=T₂−T₁) before the start (T₂) of the radio resource containing the signal, S2 (e.g., paging, RA).

In one example scenario, a WD 22 is capable of, or configured to, operate in HD-FDD mode served by a first cell (cell1) which is managed or served by a first network node 16 (NN1), e.g., gNB. The WD 22 may further operate in, or be configured in, a low activity RRC state (e.g., such as RRC IDLE state, RRC INACTIVE state etc.). During the time period ΔT1 before a time resource containing a paging occasion (PO, e.g., for the paging reception), the HD-FDD WD 22 prioritizes the DL reception (e.g., SSB reception) over the UL transmission (e.g., random access or any other UL transmission). For example, during time period ΔT1, the WD 22 switches to DL during the resources where one or more DL RSs (e.g., the SSBs) are available at the WD 22. In other resources during time period ΔT1 which do not contain the DL RSs, the WD 22 may be in DL or UL. The time resource (Rp) containing at least one PO may occur at or start at certain time instance, T2. The WD 22 may further prioritize certain types of DL reception over any UL transmission during ΔT1 before T2. In one example, the WD 22 prioritizes the TRS reception over random access or any other UL transmission during ΔT1 before T2.

Therefore, in this example, SSB and/or TRS correspond to signal S1 and paging signal in a paging resource (e.g., in PO) correspond to signal S2.

In this scenario, the NW1 may configure the following types of periodic DL signals:
SS/PBCH block (SSB) with the periodicity T_{SSB}. An example of T_{SSB} is 20 ms;
CSI-RS for tracking (TRS) with the periodicity T_{TRS}. An example of T_{TRS} is 20 ms; and/or
Paging occasions with the periodicity T_{PO}. An example of T_{PO} is 2560 ms.

In addition, the NW1 (e.g., gNB) may configure any other DL scheduling for WD 22 to receive when it is in IDLE or INACTIVE states.

The NW1 (e.g., gNB) also configures the RACH resources with the periodicity T_{RACH}. An example of T_{RACH} is 40 ms. The network node may configure any other UL transmission resources for the WD 22 to use to transmit when it is in low activity RRC state (e.g., RRC IDLE state or INACTIVE state).

When the HD-FDD WD 22 is in low activity RRC state (e.g., RRC IDLE state or INACTIVE state), the WD 22 is scheduled, required or expected to wake up (e.g., from DRX OFF duration) and become active mode (e.g., into DRX ON duration) every T_{PO}. When the WD 22 is not in active mode, the WD 22 is in the sleep mode and stops almost all the RF and Baseband processors. During the period ΔT1 (SSB/TRS measurement window) before the paging occasion in T2, the WD 22 receives SSB and/or TRS to re-synchronize with the network node and to perform AGC. This operation is also interchangeably referred to as time and/or frequency tracking and/or AGC setting. If the HD-FDD WD 22 is configured with UL resources which are fully or partially overlapped with SSB/TRS, then the WD 22 prioritizes to receive SSB/TRS and skip UL transmission. Example of an UL transmission is random access.

The period ΔT1 (SSB/TRS measurement window) may be configured by the network node 16, pre-defined, or function of paging occasion period, e.g., f(T_{PO})=min (160 ms, T_{DRX}/10). In one example, the WD 22 may determine the length of ΔT1 autonomously based on its receiver synchronization status, e.g., based on a time since a last reception, transmission, a time since last time WD 22 has been in active mode, a time since last paging, etc. In another example, the length of ΔT1 may depend on T_{DRX} and T_{RS} (reference signal transmission periodicity, also referred to as T_{SSB}). In yet another example, length of ΔT1 may depend on receiver type, e.g., whether it is a WD 22 of reduced complexity (e.g., 1 receive antenna).

FIG. 14 illustrates an example embodiment where an SSB is scheduled with the periodicity T_{SSB}. A Paging Occasion is scheduled in t5, and UL resources are scheduled in t7 and t8. In this example, it is assumed that the WD 22 is to receive SSBs for the duration ΔT1 before the start of paging occasion, T2. In this example, 4 SSBs are transmitted during ΔT1. During this duration, the WD 22 is also configured and/or scheduled with UL transmissions in t7 and t8. Since no SSB is transmitted during the UL resource in t7, the WD 22 switches to UL and can perform UL transmission. On the other hand, SSB is transmitted during the UL resource in t8. Thus, the WD 22 does not switch to UL, but instead, the WD 22 receives the SSB at t3. In this case, the UL transmission at t8 might be dropped or postponed. In this example, it is assumed that the resynchronization (AGC or time/frequency tracking) is based on SSB. In another example, the WD 22 may use CSI-RS/TRS to perform the same operation. The length of ΔT1 may also depend on the type of RS used for performing the resynchronization. In another example, the length of ΔT1 may also depend on whether the time resources are fully or partially overlapping. The time period ΔT1 may be shorter if the DL and UL resources are partially overlapping compared to if they are fully overlapping.

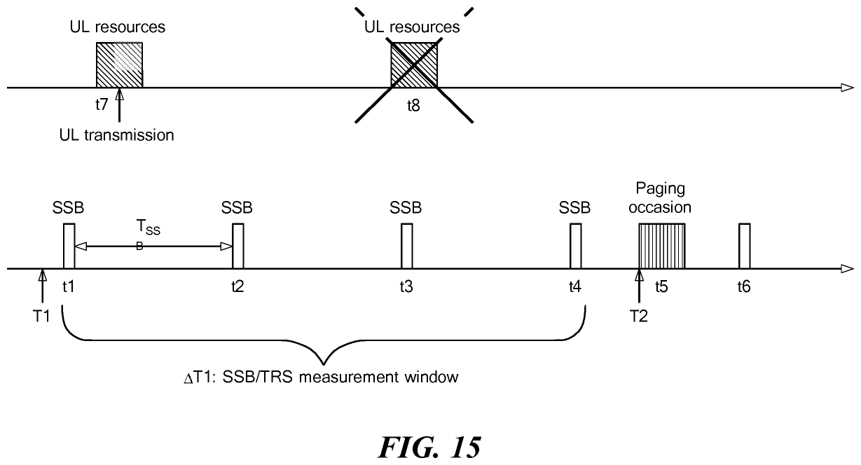

In one specific example based on FIG. 15, assuming that the DL measurement occasions during the time period ΔT1 are guaranteed in the WD 22, then the WD 22 may be required to meet the paging requirements, i.e., to correctly receive or to not miss the paging message at time t5. This implies that the WD 22 measures on the DL signals and performs the resynchronization towards the serving cell during time period t5.

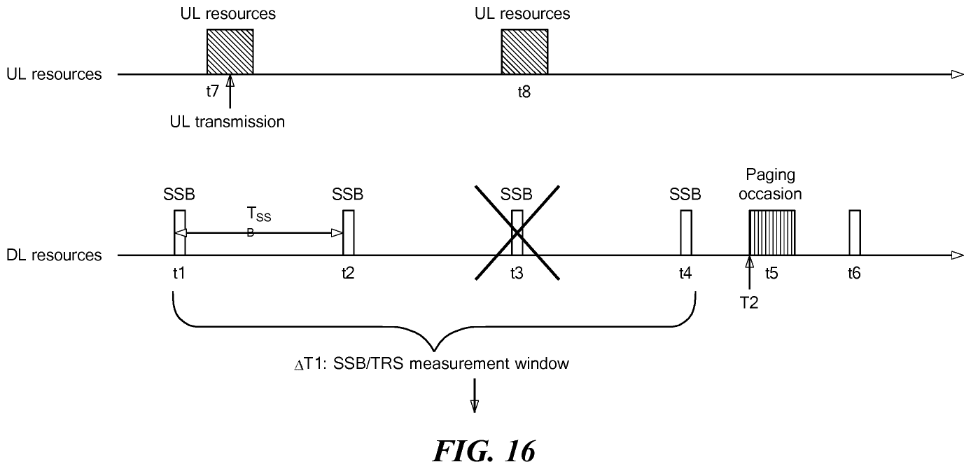

In another specific example based on FIG. 16, if WD 22 will use SSB in t3 for cell reselection measurements and SSB in t4 for paging AGC retuning, then the UL transmission at t8 might also be dropped or postponed.

In another specific example based on FIG. 16, where it is assumed that the DL measurement occasions during time period ΔT1 cannot be guaranteed in the WD 22 due to more critical UL transmission (e.g., public safety messages, positioning message) taking place in t8, then the WD 22 may be unable (drops) to receive the SSB in t3, in this case the WD 22 may not be required to fulfill the paging reception requirements, i.e., the WD 22 may be allowed to miss the paging message at time t5.

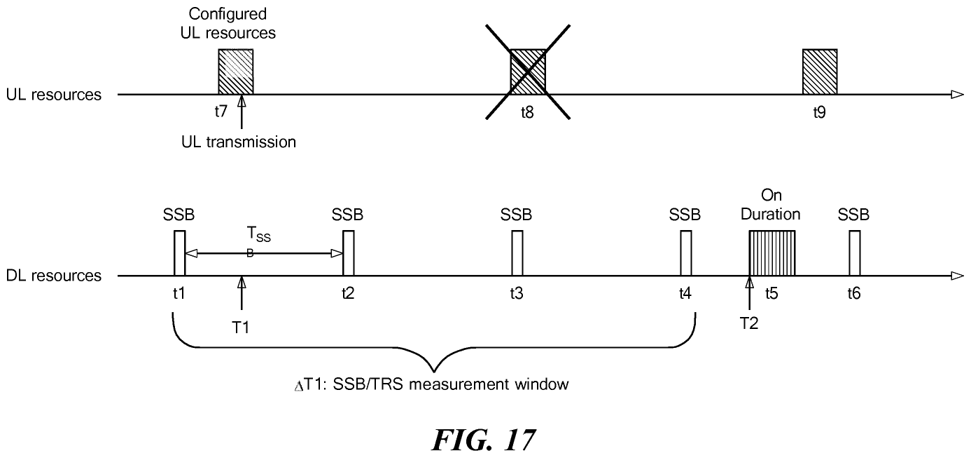

In another specific example based on FIG. 17, the WD 22 will use an SSB in t3 for cell reselection measurements but use SSB in t4 for paging AGC retuning. In this case, the WD 22 may still be required to fulfill the paging reception requirements. In another embodiment, when the WD 22 is in CONNECTED mode, during the period ΔT1 before the DL signal reception for the WD 22 configured with C-DRX, the HD-FDD WD 22 prioritizes SSB reception over random access or any other UL transmission. Optionally, the WD 22 prioritizes TRS reception over random access or any other UL transmission.

In this scenario, the network node 16 may configure the following periodic DL signals:
SS/PBCH block (SSB) with the periodicity T_{SSB}. Example of T_{SSB} is 20 ms;
CSI-RS for tracking (TRS) with the periodicity T_{TRS}. Example of T_{TRS} is 20 ms; and
Connected mode DRX (C-DRX) with the periodicity T_{DRX}. Example of T_{PO} is 320 ms.

The network node 16 also configures the UL resources in CONNECTED mode. The example of UL resources is PUCCH, CG-PUSCH, SRS.

When the HD-FDD WD 22 is in CONNECTED mode, WD 22 is scheduled to wake and become active mode during the on-duration every T_{DRX}. When WD 22 is not in active mode, the WD 22 is in the sleep mode. During the period ΔT1 (SSB/TRS measurement window) before the on-duration, the WD 22 may receive SSB and/or TRS to re-synchronize with the network node and to perform AGC. If the HD-FDD WD 22 is configured with UL resources fully or partially overlapped with SSB/TRS, the WD 22 prioritize reception of SSB/TRS and may skip UL transmission.

The SSB/TRS measurement window may be configured by the network, pre-defined, or function of DRX period, e.g., f(T_{DRX})=min (80 ms, T_{DRX}/10). In one example, the WD 22 may determine the length of ΔT1 autonomously based on its receiver synchronization status, e.g., based on time since last reception, transmission, time since last time WD 22 has been in active mode, time since last paging, etc. In another example, the length of ΔT1 may depend on T_{DRX} and T_{RS} (reference signal transmission periodicity, also referred to as T_{SSB}). In yet another example, the duration of ΔT1 may depend on receiver type, e.g., whether it is a WD 22 of reduced complexity (e.g., 1 Rx).

FIG. 16 illustrates an example embodiment where SSB are scheduled with the periodicity T_{SSB}. The On-duration is scheduled in t5, and UL resources are scheduled in t7, t8, and t9. In this example, it is assumed that the WD 22 will receive SSBs for the duration ΔT1 before the On-duration. In this example, 3 SSBs are transmitted during ΔT1. In the duration, the WD 22 needs three UL transmissions in t7, 18, and t9. Since no SSB is transmitted during the UL resource in t7, the WD 22 switches to UL and can perform UL transmission. The WD 22 can also perform UL transmission at t9. On the other hand, SSB are transmitted during the UL resource in t8, and the WD 22 does not switch to UL, and will not receive the SSB at t3.

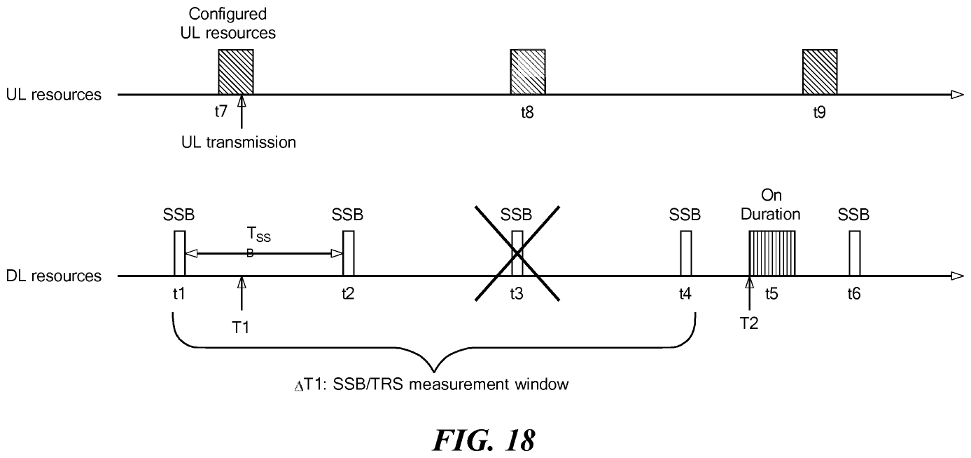

In another specific example based on FIG. 18, where an SSB is scheduled with the periodicity T_{SSB}. In the duration, the WD 22 needs three UL transmissions in t7, t8. An SSB is transmitted during the UL resource in t8, but the WD 22 is unable (drops) to receive the SSB in t3 due to more critical UL transmissions (e.g., RACH for Handover, or Link recovery etc.) taking place in t8.

Examples of one or more rules, which may be specified or configured to define the WD behavior may include one or more of the following
The HD-FDD capable WD 22 is expected to receive or shall receive a paging in a paging resource (Rp) (e.g., paging occasion) in a cell provided that at least N number of RSs (e.g., SSB, TRS, etc.) are available at the WD 22 during the last Tp period before the paging resource, Rp. It may also be specified that the WD 22 is expected to meet or shall meet one or more requirements associated with a paging reception if the above condition on N number of RSs is met;
The HD-FDD capable WD 22 is expected to receive or shall receive a paging in a paging resource (Rp) (e.g., paging occasion) in a cell provided that the WD 22 can receive or is able to receive at least N number of RSs (e.g., SSB, TRS, etc.) during the last Tp period before the paging resource, Rp. It may also be specified that the WD 22 is expected to meet or shall meet one or more requirements associated with a paging reception if the above condition on N number of RSs is met;
The HD-FDD capable WD 22 is not expected to receive or may not receive or is not required to receive or is allowed to miss a paging in a paging resource (Rp) (e.g., paging occasion) in a cell less than N number of RSs (e.g., SSB, TRS, etc.) is available at the WD 22 during the last Tp period before the paging resource, Rp. It may also be specified that the WD 22 is not expected to meet or may not meet or is not required to meet one or more requirements associated with a paging reception if the above condition on N number of RSs is not met;
The HD-FDD capable WD 22 is not expected to receive or may not receive or is allowed to miss a paging in a paging resource (Rp) (e.g., paging occasion) in a cell provided that the WD 22 cannot receive or is unable to receive at least N number of RSs (e.g., SSB, TRS, etc.) during the last Tp period before the paging resource, Rp. It may also be specified that the WD 22 is not expected to meet or may not meet or is not required to meet one or more requirements associated with a paging reception if the above condition on N number of RSs is not met;
The HD-FDD capable WD 22 drops or discards or shall drop or discard or is allowed to miss a paging in a paging resource (Rp) (e.g., paging occasion) in a cell if less than N number of RSs (e.g., SSB, TRS, etc.) is available at the WD 22 during the last Tp period before the paging resource, Rp. It may also be specified that the WD 22 is not expected to meet or may not meet or is not required to meet one or more requirements associated with a paging reception if the above condition on N number of RSs is not met; and/or
The HD-FDD capable WD 22 drops or discards or shall drop or discard or is allowed to miss a paging in a paging resource (Rp) (e.g., paging occasion) in a cell if the WD 22 cannot receive at least N number of RSs (e.g., SSB, TRS, etc.) during the last Tp period before the paging resource, Rp. It may also be specified that the WD 22 is not expected to meet or may not meet or is not required to meet one or more requirements associated with a paging reception if the above condition on N number of RSs is not met.

In another example embodiment, an HD-FDD WD 22 receives several SSBs before the random access attempts if both 4-step RA type and 2-step RA type are configured. If the SSBs are fully or partially overlapped with the scheduled UL resources, the WD 22 prioritizes to receive the SSB and skip the scheduled UL transmission.

Therefore, in this example, the SSB corresponds to signal, S1 and random access transmission/signal in a RACH resource (e.g., in RACH occasion) corresponds to signal, S2:
Step 1: When the HD-FDD WD 22 needs random access attempts, WD 22 start to schedule to receive several SSBs before attempting random access on the scheduled random access occasion.

For example, the WD 22 may schedule to receive N SSBs for ΔT1 period before the random access attempt, e.g., N=4 and ΔT1=320 ms. If the scheduled SSBs are less than N during ΔT1, the WD 22 will schedule receive all the SSBs for ΔT1 period.

As another example, the WD 22 may schedule to receive N consecutive SSBs just before the random access, e.g., N=4.

As another example, the WD 22 may schedule to receive all the SSBs for T1 period before the random access, e.g., T1=160 ms.
Step 2: When the WD 22 is configured with UL resources and they are fully or partially overlapped with the SSBs in the time domain which are scheduled to be measured in Step 1, the WD 22 prioritizes to measure SSB and WD 22 skips to UL transmission on the scheduled UL resources. Examples of UL resources are PUCCH and SRS.

If the WD 22 is configured with UL resources and they are not overlapped with the SSBs in the time domain, the WD 22 may switch to UL carrier and attempt UL transmission if necessary.

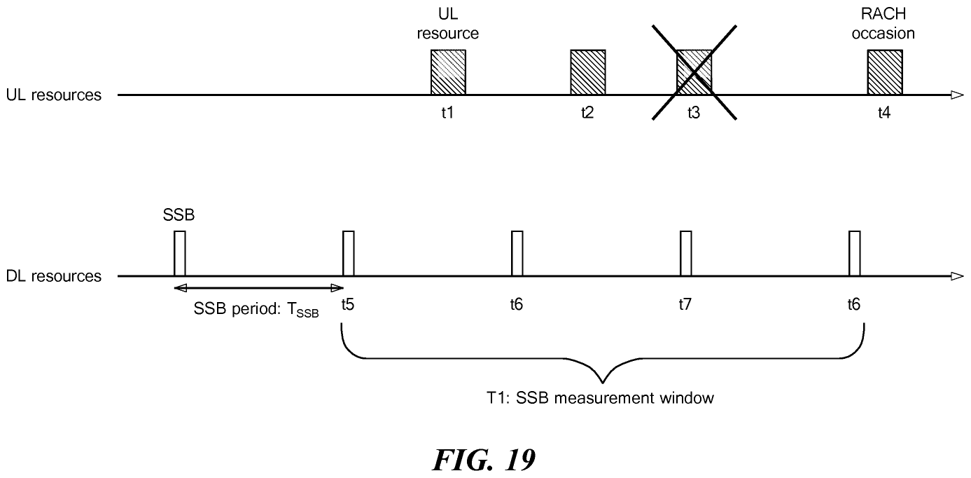

FIG. 19 is an example of the SSB measurement prioritization before random access. In this example, a RACH occasion is scheduled in t4 and 3 UL resources are scheduled in t1, t2, and t3. In the DL carrier, the SSB is transmitted with the periodicity T_{SSB}. The WD 22 needs to measure SSB samples over ΔT1 for RSRP measurements and the WD 22 is going to attempt a random access in t4. In this example, the WD 22 schedules to measure 4 SSBs from t5. During ΔT1, there are three configured UL resources. The WD 22 switches to UL and transmits signals in t1 and t2. However, in this example, the WD 22 does not transmit signal in t3 because it overlaps with SSB transmission in DL. After the WD 22 measures 4 SSBs during T1, the WD 22 estimates RSRP and select 4-step RA or 2-step RA according to the measurement results.

If the WD 22 is configured with UL resources and they are not overlapped with the SSBs in the time domain, but the time between SSB and UL resources are within the switching period between UL and DL in half-duplex operation, the WD 22 may receive SSB and the WD 22 skips to UL transmission on the scheduled UL resources. For example, it is assumed that SSB transmission ends at ta and the network node schedule to start UL transmission at TB. If the time difference TB-TA exceeds the DL-to-UL switching timing difference for the WD 22 half-duplex operation, the WD 22 may receive SSB and skip the UL transmission at TB.

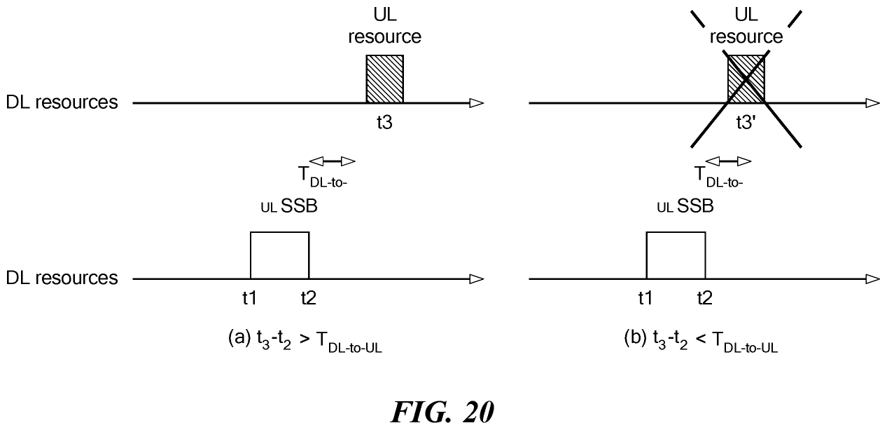

FIG. 20 is an example of UL transmission after SSB measurements. In this example, an SSB transmission starts between t₁ and t₂, and the HD-FDD DL-to-UL switching period is given by T_{DL-to-UL}. In Example (a), the UL resource is configured from t₃ and (t₃−t₂)>T_{DL-to-UL}. In this case, the WD 22 will switch to UL before t₃ and transmit UL signals. On the other hand, Example (b) the UL resource is configured from t₃′ and (t₃′−t₂)<T_{DL-to-UL}. In this case, the WD 22 skips the transmission of UL signals.
Step 3: Before the random access attempt, the WD 22 decides the RA-type based on the measured SSBs. The WD 22 starts to transmit the random access preamble on the scheduled random access occasion based on the selected RA-type.

In another embodiment, when the network node 16 schedules both 4-step RA type and 2-step RA type to the HD-FDD WDs, the network node 16 may avoid the overlapping between SSB and UL resources in the time domain.

In this embodiment, the WD 22 informs the network node whether it operates with HD-FDD. When the network node 16 is indicated the HD-FDD operation by the WD 22, it also knows the switching time from DL-to-UL (T_{DL-to_UL}) and time from UL-to-DL (T_{UL-to_DL}). The switching time DL-to-UL and UL-to-DL may be the same or different. The switching time may be informed by the WD 22 or pre-defined.

The network node 16 schedules an SSB with the period T_{SSB}. An example of T_{SSB} is 20 ms. When the network node configures 4-step RA type and 2-step RA type for random access procedure, the network node schedules UL resources for the HD-FDD WDs so that they are outside SSB transmission plus DL-to-UL/UL-to-DL switching time in the time domain. Examples of UL resources are PUCCH, SRS, and PRACH.

For example, if SSB transmission starts at T_{SSB}_start and ends at T_{SSB}_end, the network node does not schedule UL resource at least in the time window between (T_{SSB_start}−T_{UL-to-DL}) and (T_{SSB_end}+T_{DL-to-UL}).

If the network node 16 needs to schedule the UL resources during the time window between (T_{SSB_start}−T_{UL-to-DL}) and (T_{SSB_end}+T_{DL-to-UL}), the network node 16 may expect that the HD-FDD WD 22 won't transmit UL signal.

Examples of one or more rules, which may be specified or configured to define the WD 22 behavior may include one or more of the following:
The HD-FDD capable WD 22 is expected to perform or shall perform selection between 2-step RA and 4-step RA for RA transmission in a cell provided that at least N number of RSs (e.g., SSB, etc.) are available at the WD 22 during the last Tp period before the RA selection or RA transmission resource (e.g., RA transmission occasion). It may also be specified that the WD 22 is expected to meet or is required to meet one or more requirements associated with a RA selection between 2-step RA and 4-step RA, for RA transmission if the above condition on N number of RSs is met;
The HD-FDD capable WD 22 is expected to perform selection between 2-step RA and 4-step RA for RA transmission in a cell provided that the WD 22 can receive at least N number of RSs (e.g., SSB etc.) is available at the WD 22 during the last Tp period before the RA selection or RA transmission resource (e.g., RA transmission occasion). It may also be specified that the WD 22 is expected to meet or is required to meet one or more requirements associated with a RA selection between 2-step RA and 4-step RA, for RA transmission if the above condition on N number of RSs is not met;
The HD-FDD capable WD 22 is not expected to perform or is not required to perform or may not perform selection between 2-step RA and 4-step RA for RA transmission in a cell if less than N number of RSs (e.g., SSB etc.) is available at the WD 22 during the last Tp period before the RA selection or RA transmission resource (e.g., RA transmission occasion). It may also be specified that the WD 22 is not expected to meet or is not required to meet one or more requirements associated with a RA selection between 2-step RA and 4-step RA, for RA transmission if the above condition on N number of RSs is not met;
The HD-FDD capable WD 22 is not expected to perform or is not required to perform or may not perform selection between 2-step RA and 4-step RA for RA transmission in a cell if the WD 22 cannot receive at least N number of RSs (e.g., SSB etc.) during the last Tp period before the RA selection or RA transmission resource (e.g., RA transmission occasion). It may also be specified that the WD 22 is not expected to meet or is not required to meet one or more requirements associated with a RA selection between 2-step RA and 4-step RA, for RA transmission if the above condition on N number of RSs is not met;
The HD-FDD capable WD 22 is expected to perform or is required to perform or shall perform RA transmission in a PRACH occasion in a cell if the WD 22 can receive at least N number of RSs (e.g., SSB etc.) associated with the PRACH occasion during the last Tp period before the PRACH transmission resource (e.g., PRACH occasion). It may also be specified that the WD 22 is expected to meet or is required to meet one or more requirements associated with a RA transmission if the above condition on N number of RSs is met;
The HD-FDD capable WD 22 is expected to perform or is required to perform or shall perform RA transmission in a PRACH occasion in a cell if at least N number of RSs (e.g., SSB etc.) associated with the PRACH occasion is available at the WD 22 during the last Tp period before the PRACH transmission resource (e.g., PRACH occasion). It may also be specified that the WD 22 is expected to meet or is required to meet one or more requirements associated with a RA transmission if the above condition on N number of RSs is met;
The HD-FDD capable WD 22 is not expected to perform or is not required to perform or may not perform RA transmission in a PRACH occasion in a cell if the WD 22 cannot receive at least N number of RSs (e.g., SSB etc.) associated with the PRACH occasion during the last Tp period before the PRACH transmission resource (e.g., PRACH occasion). It may also be specified that the WD 22 is not expected to meet or may not meet or is not required to meet one or more requirements associated with a RA transmission if the above condition on N number of RSs is not met; and/or
The HD-FDD capable WD 22 is not expected to perform or is not required to perform or may not perform RA transmission in a PRACH occasion in a cell if less than N number of RSs (e.g., SSB etc.) associated with the PRACH occasion is available at the WD 22 during the last Tp period before the PRACH transmission resource (e.g., PRACH occasion). It may also be specified that the WD 22 is not expected to meet or may not meet or is not required to meet one or more requirements associated with a RA transmission if the above condition on N number of RSs is me

In another example embodiment, the HD-FDD WD 22 receives at least N number of SSBs between T2 and T1, before transmitting small data in the SΔT resources in the UL.

Therefore, in this example, the SSB corresponds to signal, S1 and SΔT transmission/signal in a RACH-SΔT resource or CG-SΔT resource corresponds to signal, S2.

The WD 22 may transmit small data on a RA-SΔT resource or in a CG-SΔT resource. The SΔT resource may start at time instance T2. If the WD 22 cannot receive at least N number of SSBs between T2 and T1, then the WD 22 does not transmit the SΔT resources in the UL starting from T2. The WD 22 may further postpone the SΔT transmission at a later time.

In one example, the WD 22 may need to acquire different numbers of SSBs for transmitting small data using RA-SΔT resource or CG-SΔT resource, e.g., N3 number of SSBs and N4 number of SSBs for transmitting using RA-SΔT resource or CG-SΔT resource respectively. In this case the WD 22 may select SΔT resource (RA-SΔT resource or CG-SΔT resource) which meets the FSR condition. For example, if the WD 22 has acquired N3 number of SSBs then the WD 22 uses RA-SΔT resource for SΔT. If the WD 22 has acquired N4 number of SSBs, then the WD 22 uses CG-SΔT resource for SΔT. Otherwise, if the WD 22 has acquired a number of SSBs below N3 and also below N4 then the WD 22 does not transmit SΔT data.

Examples of one or more rules, which may be specified or configured to define the WD 22 behavior may include one or more of the following:
The HD-FDD capable WD 22 is expected to transmit or shall transmit or is required to transmit SΔT in a SΔT resource (e.g., CG-SΔT or RA-SΔT resources) in a cell provided that at least N number of RSs (e.g., SSB, TRS, etc.) are available at the WD 22 during the last Tp period before the STD transmission resource;
The HD-FDD capable WD 22 is expected to transmit or shall transmit or is required to transmit SΔT in a SΔT resource (e.g., CG-SΔT or RA-SΔT resources) in a cell provided that the WD 22 can receive at least N number of RSs (e.g., SSB, TRS, etc.) during the last Tp period before the STD transmission resource;
The HD-FDD capable WD 22 is not expected to transmit or shall not transmit or is not required to transmit SΔT in a SΔT resource (e.g., CG-SΔT or RA-SΔT resources) in a cell if less than N number of RSs (e.g., SSB, TRS, etc.) is available at the WD 22 during the last Tp period before the STD transmission resource;
The HD-FDD capable WD 22 is not expected to transmit or shall not transmit or is not required to transmit SΔT in a SΔT resource (e.g., CG-SΔT or RA-SΔT resources) in a cell if the WD 22 cannot receive at least N number of RSs (e.g., SSB, TRS, etc.) during the last Tp period before the STD transmission resource;
The HD-FDD capable WD 22 is expected to perform or shall perform or is required to perform selection between CG-SΔT and CG-RA based transmission schemes for SΔT transmission in a SΔT resource (e.g., CG-SΔT or RA-SΔT resources) in a cell provided that at least N number of RSs (e.g., SSB, TRS, etc.) are available at the WD 22 during the last Tp period before the STD transmission resource.
The HD-FDD capable WD 22 is expected to perform or shall perform or is required to perform selection between CG-SΔT and CG-RA based transmission schemes for SΔT transmission in a cell provided that the WD 22 can receive at least N number of RSs (e.g., SSB, TRS, etc.) during the last Tp period before the STD transmission resource;
The HD-FDD capable WD 22 is not expected to perform or shall not perform or is not required to perform selection between CG-SΔT and CG-RA based transmission schemes for SΔT transmission in a SΔT resource (e.g., CG-SΔT or RA-SΔT resources) in a cell if less than N number of RSs (e.g., SSB, TRS, etc.) are available at the WD 22 during the last Tp period before the STD transmission resource; and
The HD-FDD capable WD 22 is not expected to perform or shall not perform or is not required to perform selection between CG-SΔT and CG-RA based transmission schemes for SΔT transmission in a cell provided that the WD 22 cannot receive at least N number of RSs (e.g., SSB, TRS, etc.) during the last Tp period before the STD transmission resource.

According to one aspect, a WD 22 is configured to communicate with a network node 16. The WD 22 includes processing circuitry 84 configured to: determine whether a first signal reception, FSR, condition is met, determine whether to operate a second signal in a radio resource Rr starting at a time T2 based at least in part on whether the FSR condition is met.

According to this aspect, in some embodiments, the FSR condition includes one of reception of at least N number of a first signal (S1) and at least N number of S1 is available at the WD 22 during a time period (ΔT) before T2 or between time instances T1 and T2; where ΔT=T2−T1 and T1<T2. In some embodiments, the FSR condition is fulfilled, then the processing circuitry 84 is further configured to postpone operation of the second signal.

According to another aspect, a method implemented in a wireless device (WD) 22 is provided. The method include determining whether a first signal reception, FSR, condition is met, and determining whether to operate a second signal in a radio resource Rr starting at a time T2 based at least in part on whether the FSR condition is met.

According to this aspect, in some embodiments, the FSR condition includes one of reception of at least N number of a first signal (S1) and at least N number of S1 is available at the WD 22 during a time period (ΔT) before T2 or between time instances T1 and T2; where ΔT=T2−T1 and T1<T2. In some embodiments, the FSR condition is fulfilled, the method also includes postponing operation of the second signal.

Other example embodiments may include one or more of the following:
Example 1. A wireless device (WD) configured to communicate with a network node, the WD comprising processing circuitry configured to;
determine whether a first signal reception, FSR, condition is met; and
determine whether to operate a second signal in a radio resource Rr starting at a time T2 based at least in part on whether the FSR condition is met.
Example 2. The WD of Example 1, wherein the FSR condition includes one of reception of at least N number of a first signal (S1) and at least N number of S1 is available at the WD during a time period (ΔT) before T2 or between time instances T1 and T2; where ΔT=T2−T1 and T1<T2.
Example 3. The WD of Example 1, wherein, when the FSR condition is fulfilled, then the processing circuitry is further configured to postpone operation of the second signal.
Example 4. A method implemented in a wireless device (WD), the method comprising:
determining whether a first signal reception, FSR, condition is met; and
determining whether to operate a second signal in a radio resource Rr starting at a time T2 based at least in part on whether the FSR condition is met.
Example 5. The method of Example 4, wherein the FSR condition includes one of reception of at least N number of a first signal (S1) and at least N number of S1 is available at the WD during a time period (ΔT) before T2 or between time instances T1 and T2; where ΔT=T2−T1 and T1<T2.
Example 6. The method of Example 4, wherein, when the FSR condition is fulfilled, further comprising postponing operation of the second signal.

As will be appreciated by one of skill in the art, the concepts described herein may be embodied as a method, data processing system, computer program product and/or computer storage media storing an executable computer program. Accordingly, the concepts described herein may take the form of an entirely hardware embodiment, an entirely software embodiment or an embodiment combining software and hardware aspects all generally referred to herein as a “circuit” or “module.” Any process, step, action and/or functionality described herein may be performed by, and/or associated to, a corresponding module, which may be implemented in software and/or firmware and/or hardware. Furthermore, the disclosure may take the form of a computer program product on a tangible computer usable storage medium having computer program code embodied in the medium that may be executed by a computer. Any suitable tangible computer readable medium may be utilized including hard disks, CD-ROMs, electronic storage devices, optical storage devices, or magnetic storage devices.

Some embodiments are described herein with reference to flowchart illustrations and/or block diagrams of methods, systems and computer program products. It will be understood that each block of the flowchart illustrations and/or block diagrams, and combinations of blocks in the flowchart illustrations and/or block diagrams, may be implemented by computer program instructions. These computer program instructions may be provided to a processor of a general purpose computer (to thereby create a special purpose computer), special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable memory or storage medium that can direct a computer or other programmable data processing apparatus to function in a particular manner, such that the instructions stored in the computer readable memory produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions/acts specified in the flowchart and/or block diagram block or blocks.

It is to be understood that the functions/acts noted in the blocks may occur out of the order noted in the operational illustrations. For example, two blocks shown in succession may in fact be executed substantially concurrently or the blocks may sometimes be executed in the reverse order, depending upon the functionality/acts involved. Although some of the diagrams include arrows on communication paths to show a primary direction of communication, it is to be understood that communication may occur in the opposite direction to the depicted arrows.

Computer program code for carrying out operations of the concepts described herein may be written in an object oriented programming language such as Python, Java® or C++. However, the computer program code for carrying out operations of the disclosure may also be written in conventional procedural programming languages, such as the “C” programming language. The program code may execute entirely on the user's computer, partly on the user's computer, as a stand-alone software package, partly on the user's computer and partly on a remote computer or entirely on the remote computer. In the latter scenario, the remote computer may be connected to the user's computer through a local area network (LAN) or a wide area network (WAN), or the connection may be made to an external computer (for example, through the Internet using an Internet Service Provider).

Many different embodiments have been disclosed herein, in connection with the above description and the drawings. It will be understood that it would be unduly repetitious and obfuscating to literally describe and illustrate every combination and subcombination of these embodiments. Accordingly, all embodiments may be combined in any way and/or combination, and the present specification, including the drawings, shall be construed to constitute a complete written description of all combinations and subcombinations of the embodiments described herein, and of the manner and process of making and using them, and shall support claims to any such combination or subcombination.

Abbreviations that may be used in the preceding description include:
AFC Automatic Frequency Correction
AGC Automatic Gain Control
C-DRX Connected mode DRX
CG Configured Grant
CSI-RS Channel State Information Reference Signal
DCI Downlink Control Information
DL Downlink
DMRS Demodulation Reference Signal
DRX Discontinuous Reception
eDRX Enhanced DRX
FD-FDD Full-Duplex Frequency Division Duplex
gNB Next generation Node B
HD-FDD Half-Duplex Frequency Division Duplex
MAC Medium Access Control
PBCH Physical Broadcast Channel
PDCCH Physical Downlink Control Channel
PO Paging Occasion
PRACH Physical Random Access Channel
PRS Positioning Reference Signal
PUSCH Physical Uplink Shared Channel
RA Random Access
RACH Random access channel
RAR Random Access Response
RedCap Reduced Capability
RF Radio Frequency
RO Random access channel occasion
RRC Radio Resource Control
RSRP Received Signal Received Power
SCS Subcarrier Spacing
SFN System Frame Number
SIB System Information Block
SR Scheduling Request
SRS Sounding Reference Signal
SDT Small Data Transmission
SSB SS/PBCH block
SS/PBCH block Synchronization signal and PBCH block
TA Timing Advance
TDD Time Division Duplex
TRS Tracking Reference Signal
UE User equipment
UL Uplink
WD Wireless Device

It will be appreciated by persons skilled in the art that the embodiments described herein are not limited to what has been particularly shown and described herein above. In addition, unless mention was made above to the contrary, it should be noted that all of the accompanying drawings are not to scale. A variety of modifications and variations are possible in light of the above teachings without departing from the scope of the following claims.

1. A wireless device, WD, configured to communicate with a network node in a half-duplex frequency division duplex, HD-FDD, mode, the WD comprising processing circuitry configured to:
determine whether a first signal reception, FSR, condition is met, the FSR condition including one of receipt and availability of at least N reference signals during a time interval ΔT ending at a time T2, N being an integer greater than zero; and
provided that the FSR condition is met, receive a paging signal on a paging resource at the time T2.

2. The WD of claim 1, wherein the processing circuitry is further configured to prioritize downlink reception over uplink transmission during the time interval ΔT.

3. The WD of claim 1, wherein the processing circuitry is further configured to prioritize reception of the at least N reference signals over transmission of a random access.

4.-6. (canceled)

7. The WD of claim 1, wherein the processing circuitry is further configured to prioritize downlink reception of the at least N reference signals to enable synchronization between the WD and the network node prior to a paging occasion that starts at the time T2.

8. The WD of claim 1, wherein the at least N reference signals have a bandwidth exceeding a first threshold.

9. The WD of claim 1, wherein the at least N2 reference signals during the time interval ΔT that have a bandwidth that falls below a second threshold, N2 being an integer greater than 1.

10.-12. (canceled)

13. The WD of claim 1, wherein, when the FSR condition is not met, the processing circuitry is further configured to one of postpone, defer and delay receiving the paging signal.

14. The WD of claim 1, wherein, when the FSR condition is not met, the processing circuitry is further configured to one of postpone, defer and delay receiving the paging signal until the FSR condition is met.

15. (canceled)

16. (canceled)

17. The WD of claim 1, wherein, when the WD is in a low-activity radio resource control, RRC state, the processing circuitry is further configured to re-synchronize with the network node and to perform automatic gain control during the time interval ΔT.

18. The WD of claim 1, wherein ΔT is determined based at least in part on one of a synchronization status of the WD, a discontinuous reception time, and a reference signal transmission periodicity.

19. (canceled)

20. A method in a wireless device, WD, configured to communicate with a network node in a half-duplex frequency division duplex, HD-FDD, mode, the method comprising:
determining whether a first signal reception, FSR, condition is met, the FSR condition including one of receipt and availability of at least N reference signals during a time interval ΔT ending at a time T2, N being an integer greater than zero; and
provided that the FSR condition is met, a receiving paging signal on a paging resource at the time T2.

21. The method of claim 20, further comprising prioritizing downlink reception over uplink transmission during the time interval ΔT.

22. The method of claim 20, further comprising prioritizing reception of the at least N reference signals over transmission of a random access.

23.-25. (canceled)

26. The method of claim 20, further comprising, prioritizing downlink reception of the at least N reference signals to enable synchronization between the WD and the network node prior to a paging occasion that starts at the time T2.

27. The method of claim 20, wherein the FSR condition includes receiving at least N1 number of reference signals during the time interval ΔT that have a bandwidth exceeding a first threshold.

28. The method of claim 20, wherein the at least N2 reference signals during the time interval ΔT that have a bandwidth that falls below a second threshold, N2 being an integer greater than 1.

29.-31. (canceled)

32. The method of claim 20, further comprising, when the FSR condition is not met, one of postponing, deferring and delaying receiving the paging signal.

33. The method of claim 20, further comprising, when the FSR condition is not met, one of postponing, deferring and delaying operating the further signal until the FSR condition is met.

34. (canceled)

35. (canceled)

36. The method of claim 20, wherein, when the WD is in a low-activity radio resource control, RRC state, configuring the WD to re-synchronize with the network node and to perform automatic gain control during the time interval ΔT.

37. The method of claim 20, wherein ΔT is determined based at least in part on one of a synchronization status of the WD, a discontinuous reception time, and a reference signal transmission periodicity.

38.-48. (canceled)
